(19) United States
(12) Patent Application Publication
(10) Pub. No.: US 2026/0220238 A1
(43) Pub. Date: Jul. 30, 2026

(54) INFORMATION PROCESSING APPARATUS, INFORMATION PROCESSING METHOD, AND NON-TRASITORY RECORDING MEDIUM

(71) Applicant: NEC Corporation, Tokyo (JP)

(72) Inventor: Ryoma OAMI, Tokyo (JP)

(73) Assignee: NEC Corporation, Tokyo (JP)

(21) Appl. No.: 19/146,987

(22) PCT Filed: Mar. 22, 2023
(86) PCT No.: PCT/JP2023/011178

§ 371 Date: Jul. 10, 2025

(51) Int. Cl. G06F 21/32

(52) U.S. Cl. CPC G06F 21/32

(57) ABSTRACT

An information processing apparatus including: an authentication unit that determines a success or failure of authentication of a target based on predetermined conditions and a result of a matching process that determines a success or failure of matching of the target using a matching score generated from biometric information of the target; an estimation unit that estimates estimated authentication information regarding the success or failure of authentication of the target in case the authentication unit repeats the matching process a predetermined number of times based on a past authentication result by the authentication unit; and an output unit that outputs the estimated authentication information.

### TECHNICAL FIELD

This disclosure relates to the technical field of information processing apparatus, information processing methods, and recording media.

### BACKGROUND ART

Patent Literature 1 describes a face authentication apparatus including a face image acquisition unit for acquiring a face image for authentication, a comparison unit for performing face authentication by calculating the degree of similarity between face information based on the face image for authentication and fiducial face information for each registered user and comparing the degree of similarity with a threshold value, a prediction unit for predicting changes in the degree of similarity based on a history of the degree of similarity when authentication is successful, and a threshold value changing unit for changing the threshold value based on the result of the prediction.

Patent Literature 2 describes a face authentication apparatus that includes a face image acquisition section for acquiring a face image for authentication, a comparison section for performing face authentication by calculating the degree of similarity between face information based on the face image for authentication and fiducial face information for each registered user and comparing it with a threshold value, a prediction section for predicting changes in the degree of similarity based on the history of the degree of similarity when authentication is successful, and a threshold value changing section for changing the threshold value based on the result of the prediction.

Patent Literature 3 describes an evaluation apparatus that includes a generation unit that generates multiple sets from a first population of biometric data collected from multiple people, where the number of biometric data in each set is smaller than that in the first population and at least some of the biometric data in each set are different from each other, and a first estimation unit that estimates the probability density distribution of the similarity between pairs of different persons for each of the multiple sets; a calculation unit that calculates the acceptance rate of different persons for each of the multiple sets based on the probability density distribution; and a second estimation unit that estimates the integrated acceptance rate of different persons from the statistics of the acceptance rates of different persons for each of the multiple sets calculated by the calculation unit.

Patent Literature 4 describes an evaluation apparatus including: a mode selection means for selecting an operation mode for determining whether a person imaged by a camera is a registered person or not, or a setting mode for setting a threshold to be used in the determination; a person determination means for determining, when the operation mode is selected, that a person whose similarity between extracted face feature information and stored face feature information is equal to or greater than the threshold is a registered person; and an output means for outputting the determination result of the person determination means; an output means for outputting the determination result of the person determination means, and a threshold setting means for setting a threshold value based on the similarity between the face feature information extracted by imaging the registered person with a camera and the stored face feature information, and the similarity between the face feature information extracted by imaging a person other than the registered person with a camera and the stored face feature information, when the setting mode is selected.

Patent Literature 5 describes a person recognition apparatus including: a biometric information input means for acquiring a target biometric information that is a biometric information of the target, registered biometric information storing means for storing, in advance, user biometric information that is biometric information of multiple users including the target, a matching section that compares the target biometric information acquired by the biometric information input section with the user biometric information stored in the biometric information registration memory section, an authentication history information memory section that stores the matching result between the target biometric information and the user biometric information as authentication history information, an authentication threshold determination section that determines an authentication threshold for authenticating the user by judging the degree of match of the matching result based on the authentication history information, and an authentication determination section that determines the authentication of the target based on the authentication threshold determined by the authentication threshold determination section and the biometric information acquired by the input apparatus.

Patent Literature 6 describes a biometric authentication apparatus that reads the unevenness information of the wrinkles of the same finger of the same person to be authenticated m times, calculates the individual errors for mC2 combinations that are obtained by selecting arbitrary two among these, calculates the similarity from the calculated multiple errors, obtains the FRR (false rejection rate) characteristic curve and FAR (false acceptance rate) characteristic curve of that person from the similarity, sets a threshold specific to the individual based on these characteristic curves, compares the unevenness information of the finger wrinkles of the individual to be authenticated with the unevenness information of the finger wrinkles of that individual that has been registered in advance, and performs personal authentication using the threshold specific to that individual.

### CITATION LIST

### Patent Literature

Patent Literature 1: WO2019/138840A
Patent Literature 2: JP2019-125002A
Patent Literature 3: JP2018-028815A
Patent Literature 4: JP2014-063251A
Patent Literature 5: JP2012-123526A
Patent Literature 6: JP2001-021309A

### SUMMARY

It is an example object of this disclosure to provide an information processing apparatus, an information processing method, and a recording medium that are intended to improve the techniques/technologies disclosed in Citation List.

### Solution to Problem

An information processing apparatus according to an example aspect includes: an authentication unit that determines a success or failure of authentication of a target based on predetermined conditions and a result of a matching process that determines a success or failure of matching of the target using a matching score generated from biometric information of the target; an estimation unit that estimates estimated authentication information regarding the success or failure of authentication of the target in case the authentication unit repeats the matching process a predetermined number of times based on a past authentication result by the authentication unit; and an output unit that outputs the estimated authentication information.

An information processing method according to an example aspect includes: determining a success or failure of authentication of a target based on predetermined conditions and a result of a matching process that determines a success or failure of matching of the target using a matching score generated from biometric information of the target; estimating estimated authentication information regarding the success or failure of authentication of the target in case the matching process is repeated a predetermined number of times based on a past authentication result; and outputting the estimated authentication information.

A recording medium according to an example aspect is a recording medium on which a computer program that allows a computer to execute an information processing method is recorded, the information processing method including: determining a success or failure of authentication of a target based on predetermined conditions and a result of a matching process that determines a success or failure of matching of the target using a matching score generated from biometric information of the target; estimating estimated authentication information regarding the success or failure of authentication of the target in case the matching process is repeated a predetermined number of times based on a past authentication result; and outputting the estimated authentication information.

### BRIEF DESCRIPTION OF DRAWINGS

FIG. 1 is a block diagram illustrating a configuration of an information processing apparatus according to this disclosure.

FIG. 2 is a block diagram illustrating a configuration of an information processing apparatus according to this disclosure.

FIG. 3 is a flowchart illustrating a flow of an information processing operation of the information processing apparatus according to this disclosure.

FIG. 4 is a conceptual diagram illustrating an overview of an information processing operation of an information processing apparatus according to this disclosure.

FIG. 5 is a flowchart illustrating a flow of an information processing operation of the information processing apparatus according to this disclosure.

FIG. 6 is a flowchart illustrating a flow of an information processing operation of the information processing apparatus according to this disclosure.

FIG. 7 is a block diagram illustrating a configuration of an information processing apparatus according to this disclosure.

FIG. 8 is a flowchart illustrating a flow of an information processing operation of the information processing apparatus according to this disclosure.

FIG. 9 is a flowchart illustrating a flow of an information processing operation of the information processing apparatus according to this disclosure.

FIG. 10 is a flowchart illustrating a flow of an information processing operation of the information processing apparatus according to this disclosure.

FIG. 11 is a block diagram illustrating a configuration of an information processing apparatus according to this disclosure.

FIG. 12 is a flowchart illustrating a flow of an information processing operation of the information processing apparatus according to this disclosure.

FIG. 13 is a conceptual diagram showing an example of an output from the information processing apparatus according to this disclosure.

FIG. 14 is a block diagram illustrating a configuration of an information processing apparatus according to this disclosure.

FIG. 15 is a flowchart illustrating a flow of an information processing operation of the information processing apparatus according to this disclosure.

FIG. 16 is a conceptual diagram showing an example of an output from the information processing apparatus according to this disclosure.

FIG. 17 is a block diagram illustrating a configuration of an information processing apparatus according to this disclosure.

FIG. 18 is a conceptual diagram showing an example of an output from the information processing apparatus according to this disclosure.

FIG. 19 is a block diagram illustrating a configuration of an information processing apparatus according to this disclosure.

### DESCRIPTION OF EXAMPLE EMBODIMENTS

The following describes embodiments of the information processing apparatus, the information processing method, and the recording medium with reference to the drawings.

### 1: First Example Embodiment

A first embodiment of an information processing apparatus, information processing method, and recording medium is described. The first embodiment of the information processing apparatus, information processing method, and recording medium will be described below using an information processing apparatus 1 to which the first embodiment of the information processing apparatus, information processing method, and recording medium is applied.

### [1-1: Configuration of the Information Processing Apparatus 1]

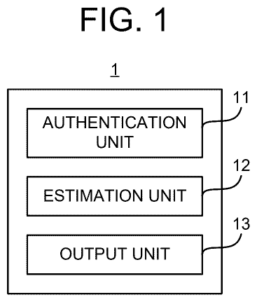

FIG. 1 is a block diagram showing the configuration of the information processing apparatus 1 according to the first embodiment. As shown in FIG. 1, the information processing apparatus 1 includes an authentication unit 11, an estimation unit 12, and an output unit 13. The authentication unit 11 determines a success or failure of authentication of a target based on predetermined conditions and a result of a matching process that determines a success or failure of matching of the target using a matching score generated from biometric information of the target. The estimation unit 12 estimates estimated authentication information regarding the success or failure of authentication of the target in case the authentication unit 11 repeats/iterates/retries the matching process a predetermined number of times based on a past authentication result by the authentication unit 11. The output unit 13 outputs the estimated authentication information.

### [1-2: Technical Effect of the Information Processing Apparatus 1]

The information processing apparatus 1 according to the first embodiment can provide information about the success or failure of authentication of the target in case the matching process is repeated until the predetermined number of times, the information is estimated based on the past authentication result.

### 2: Second Example Embodiment

Next, a second embodiment of the information processing apparatus, information processing method, and recording medium will be described. The second embodiment of the information processing apparatus, information processing method, and recording medium will be described using an information processing apparatus 2 to which the second embodiment of the information processing apparatus, information processing method, and recording medium is applied.

### [2-1: Configuration of the Information Processing Apparatus 2]

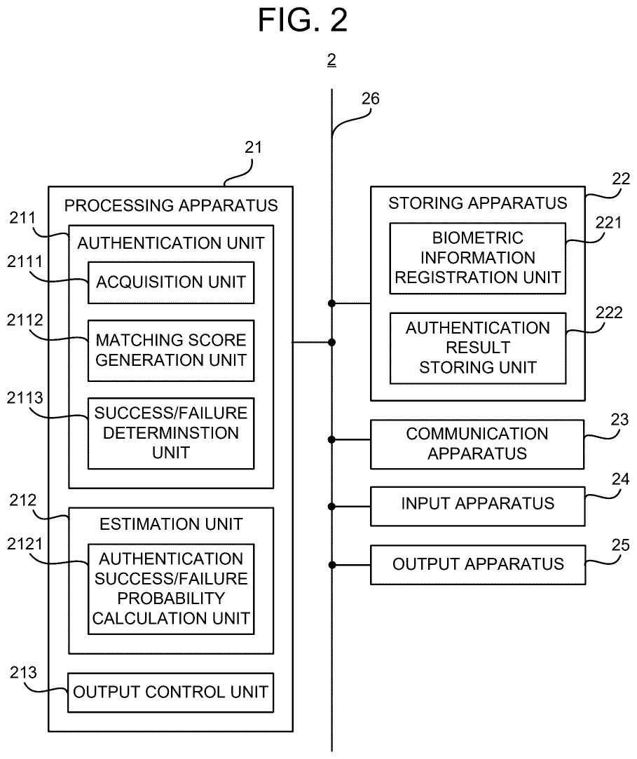

FIG. 2 is a block diagram showing the configuration of the information processing apparatus 2 according to the second embodiment. As shown in FIG. 2, the information processing apparatus 2 includes a processing apparatus 21 and a storing apparatus 22. Furthermore, the information processing apparatus 2 may include a communication apparatus 23, an input apparatus 24, and an output apparatus 25. However, the information processing apparatus 2 may not include at least one of the communication apparatus 23, the input apparatus 24, and the output apparatus 25. The processing apparatus 21, the storing apparatus 22, the communication apparatus 23, the input apparatus 24, and the output apparatus 25 may be connected via a data bus 26.

The processing apparatus 21 may be, for example, a CPU (Central Processing Unit), a GPU (Graphics Processing Unit), and/or an FPGA (Field Programmable Gate Array). The processing apparatus 21 reads a computer program. For example, the processing apparatus 21 may read a computer program stored in the storing apparatus 22. For example, the processing apparatus 21 may read a computer program stored in a computer-readable and non-temporary recording medium using a recording medium reading apparatus (e.g., the input apparatus 24 described later) provided in the information processing apparatus 2. The processing apparatus 21 may acquire (i.e., download or load) a computer program from an unillustrated apparatus located outside the information processing apparatus 2 via the communication apparatus 23 (or other communication apparatus). The processing apparatus 21 executes the loaded computer program. As a result, logical function blocks for executing operations to be performed by the information processing apparatus 2 are realized within the processing apparatus 21. In other words, the processing apparatus 21 functions as a controller capable of realizing logical functional blocks for executing the operations (i.e., processing) that the information processing apparatus 2 should perform.

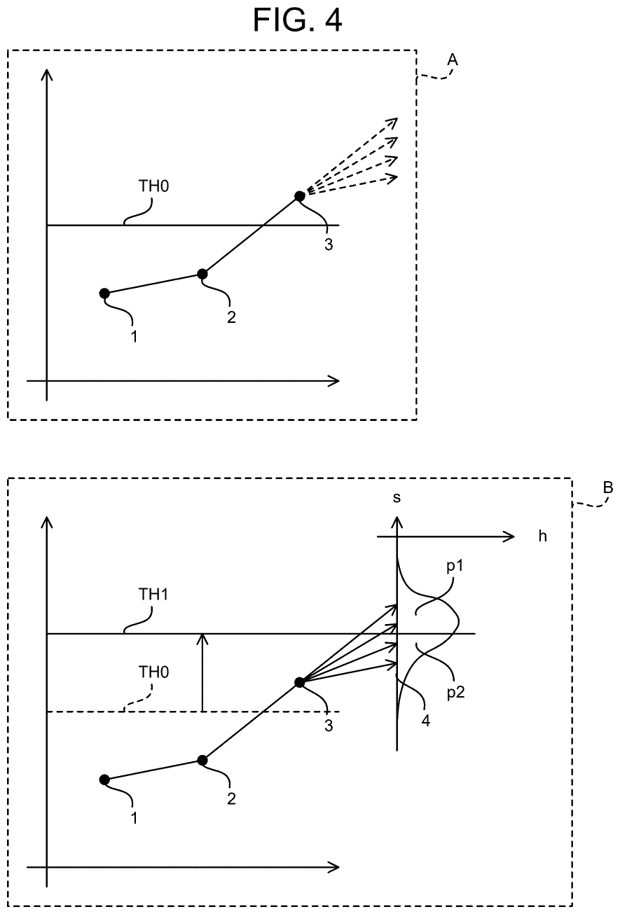

FIG. 2 shows an example of logical functional blocks realized within the processing apparatus 21 for executing information processing operations. As shown in FIG. 2, the processing apparatus 21 implements an authentication unit 211, which is a specific example of the “authentication unit” described in the Supplementary Note described later, an estimation unit 212, which is a specific example of the “estimation unit” described in the Supplementary Note described later, and an output control unit 213, which is a specific example of the “output unit” described in the Supplementary Note described later. The authentication unit 211 may include an acquisition unit 2111, a matching score generation unit 2112, and a success/failure determination unit 2113. The estimation unit 212 may include an authentication success/failure probability calculation unit 2121. The details of the operation of each of the authentication unit 211, the estimation unit 212, and the output control unit 213 will be explained later with reference to FIG. 4.

The storing apparatus 22 is capable of storing desired data. For example, the storing apparatus 22 may temporarily store a computer program executed by the processing apparatus 21. The storing apparatus 22 may temporarily store data that the processing apparatus 21 temporarily uses in case of executing a computer program. The storing apparatus 22 may store data that the information processing apparatus 2 stores long-term. Note that the storing apparatus 22 may be RAM (Random Access Memory), ROM (Read Only Memory), a hard disk apparatus, an optical magnetic disk apparatus, an SSD (Solid State Drive), and a disk array apparatus. In other words, the storing apparatus 22 may include a non-temporary recording medium. The storing apparatus 22 may implement a registered biometric information registration unit 221 and am authentication result storing unit 222.

The communication apparatus 23 is capable of communicating with an external apparatus of the information processing apparatus 2 via an unillustrated communication network. The communication apparatus 23 may be a communication interface based on standards such as Ethernet (registered trademark), Wi-Fi (registered trademark), Bluetooth (registered trademark), or USB (Universal Serial Bus).

The input apparatus 24 is an apparatus that accepts information input to the information processing apparatus 2 from outside the information processing apparatus 2. For example, the input apparatus 24 may include an operation apparatus (e.g., at least one of a keyboard, a mouse, and a touch panel) that can be operated by an operator of the information processing apparatus 2. For example, the input apparatus 24 may include a reading apparatus that can read information recorded as data on a recording medium that can be attached to the information processing apparatus 2.

The output apparatus 25 is an apparatus that outputs information to the outside of the information processing apparatus 2. For example, the output apparatus 25 may output information as images. In other words, the output apparatus 25 may include a display apparatus (a so-called display) capable of displaying images indicating the information to be output. For example, the output apparatus 25 may output information as sound. In other words, the output apparatus 25 may include a sound apparatus (i.e., a speaker) capable of outputting sound. Furthermore, for example, the output apparatus 25 may output information onto paper. In other words, the output apparatus 25 may include a printing apparatus (i.e., a printer) capable of printing desired information onto paper.

### [2-2: Authentication Operation Performed by the Information Processing Apparatus 2]

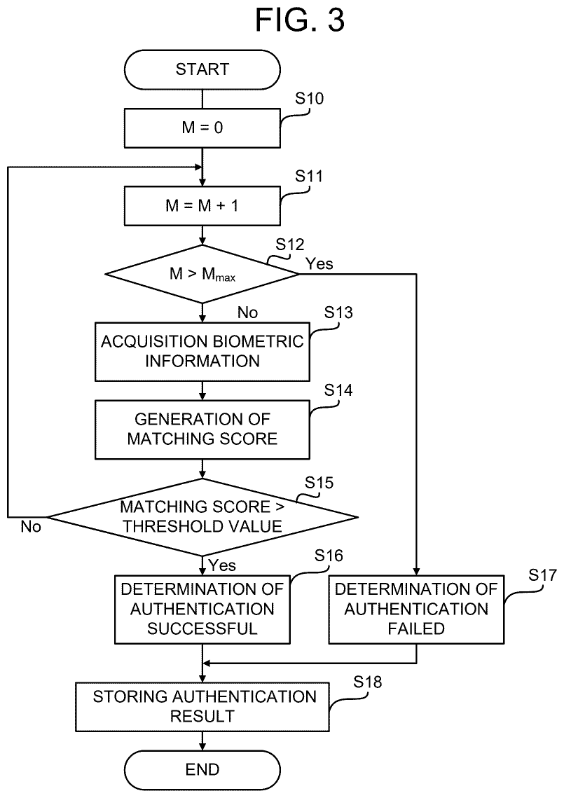

Referring to FIG. 3, the flow of the authentication operation performed by the information processing apparatus 2 will be explained. FIG. 3 is a flowchart showing the flow of the authentication operation performed by the information processing apparatus 2.

As shown in FIG. 3, the authentication unit 211 sets “M” to ‘0’ (step S10). “M” indicates number of times of a repetition/iteration/retry of the matching process. The repetition of the matching process is ended/finished/completed/terminated in case the matching score exceeds a matching score threshold value. Alternatively, the repetition of the matching process is ended in case upper a limit number of times of repetitions “Mₘₐₓ” is reached. The repetition of the matching process may be performed at predetermined intervals. Alternatively, the repetition of the matching process may be performed at intervals corresponding to the distance between the target and the camera that captures the target.

The authentication unit 211 increments “M” by “1” (step S11). The authentication unit 211 determines whether ‘M’ exceeds “Mₘₐₓ” (step S12).

In case “M” has not exceeded “Mₘₐₓ” (step S12: No), the authentication unit 211 performs the matching process. The matching process is a process that determines the success or failure of matching of the target based on the matching score. The authentication unit 211 determines the success or failure of authentication of the target based on the result of the matching process and the predetermined conditions. The predetermined conditions include a condition for determining that the authentication of the target is successful and ending the repetition of the matching process in case the matching score exceeds the matching score threshold value, and a condition for ending the repetitions in case the authentication unit 211 repeats the matching process the upper limit number of times of repetitions “Mₘₐₓ”.

The acquisition unit 2111 acquires the biometric information of the target (step S13). The acquisition unit 2111 may acquire the biometric information of the target by capturing it with a camera. In this case, the biometric information may be a living body image such as a face image, iris image, fingerprint image, or vein image. The biometric information may also be features extracted from the living body image. The acquisition unit 2111 may acquire the biometric information of the target captured by a microphone. In this case, the biometric information may be voice information, etc.

The matching score generation unit 2112 generates the matching score using the biometric information (step S14). The matching score generation unit 2112 generates the matching score based on the biometric information acquired and the biometric information registered in the biometric information registration unit 221. The matching score is a score corresponding to the result of matching the biometric information acquired with the biometric information registered. The matching score indicates the degree of matching. The matching score may also indicate the degree of similarity between the biometric information. In this case, a similarity score may be generated as the matching score.

The success/failure determination unit 2113 determines whether the matching score exceeds the matching score threshold value and makes a determination of the success or failure of matching (step S15). In case the matching score exceeds the matching score threshold value (step S15: Yes), the authentication unit 211 determines that the authentication of the target is successful (step S16).

In case the matching score does not exceed the matching score threshold value (step S15: No), return to step S11 and perform the above the matching process. In case “M” exceeds “Mₘₐₓ” (step S12: Yes), the authentication unit 211 determines that authentication of the target has failed (step S17).

The authentication unit 211 stores authentication results in the authentication result storing unit 222 (step S18). The past authentication result stored in the authentication result storing unit 222 includes information indicating final time that the repetition of the matching process has ended, and the matching score at the final time (referred to as “final matching score”).

The upper limit number of times of repetitions “Mₘₐₓ” may be set according to, for example, the characteristics of the authentication mechanism used by the authentication unit 211, the environment in which authentication is performed, and the application of authentication. The upper limit number of times of repetitions may be set to a number that is not expected to increase the matching score even in case the upper limit number of times of repetitions or more the matching process are repeated.

Graph A in FIG. 4 shows an example of the authentication result in case the authentication is performed while the target is moving toward the camera. The horizontal axis in Graph A may represent a quantity determined based on the distance between the target approaching the camera and the camera (e.g., the inverse of the distance, which decreases as the distance increases). The horizontal axis in Graph A may represent a quantity indicating the size of the target in the image, such as the distance between the two eyes of the target or the size of the face. Alternatively, the horizontal axis in Graph A may represent time. The vertical axis shown in graph A represents the magnitude of the matching score, which indicates the degree of matching. Additionally, the magnitude of the matching score threshold value TH0 used in case the matching process was performed is shown parallel to the horizontal axis.

Graph A in FIG. 4 illustrates a case where the matching score generated in the first matching process and the matching score generated in the second matching process do not exceed the matching score threshold value TH0, and the matching score generated in the third matching process exceeds the matching score threshold value TH0, resulting in the repetitions ending. In the case illustrated in graph A, since the matching score generated in the third matching process exceeds the matching score threshold value TH0, the final time is 3. In the case illustrated in graph A, the fourth and subsequent matching processes are not performed, and the matching score in the case where the fourth and subsequent matching processes are performed are unknown.

The estimation unit 212 of the present embodiment estimates the estimated authentication information of the target in case the authentication unit 211 repeats the matching process up to the predetermined number of times based on the past authentication result by the authentication unit 211. The predetermined number of times may be a number larger than the final time. The predetermined number of times may be the upper limit number of times of repetitions aforementioned.

As illustrated in graph B of FIG. 4, in case the success or failure of matching determination is made using the matching score threshold value TH1, which is greater than TH0, the matching score at the third matching process does not exceed the matching score threshold value TH1, so the fourth and subsequent matching processes are performed. The information processing apparatus 2 according to the present embodiment determines an occurrence probability of the matching score generated by the matching process that was not actually performed.

In this embodiment, an occurrence probability of a next time matching score generated in the matching process performed at the next time of the final time may be information dependent on the final matching score of the final time. As illustrated in Graph B, in case the matching score increases with each implementation of the matching process, the next time matching score generated in the matching process implemented at the next time of the final time may have a high probability of being a larger value than the final matching score of the final time.

As illustrated in Graph B of FIG. 4, the estimation unit 212 may be used to calculate the occurrence probability h of the matching score s in the fourth matching process. For example, Graph B illustrates that the occurrence probability h of the matching score s indicated by the top arrow is smaller than the occurrence probability h of the matching score s indicated by the second arrow from the top. Additionally, Graph B illustrates that the occurrence probability h of the matching score s indicated by the second arrow from the top is larger than the occurrence probability h of the matching score s indicated by the third arrow from the top. Furthermore, Graph B illustrates that the occurrence probability h of the matching score s indicated by the third arrow from the top is larger than the occurrence probability h of the matching score s indicated by the bottom arrow.

The occurrence probability h may vary depending on the number of times the matching process is performed. In other words, the occurrence probability of the matching score acquired in the fifth matching process may differ from the occurrence probability of the matching score acquired in the fourth matching process. The estimation unit 212 uses the occurrence probability of the next time matching score to find the occurrence probability of the matching score generated in case the matching process is performed the next time of the final time and subsequent times. By repeating this process, the estimation unit 212 can determine the occurrence probability of the matching score generated in case the matching process is repeated from the final time to the predetermined number of times according to the final matching score.

The estimation unit 212 may determine the occurrence probability using an occurrence probability estimation model. The occurrence probability estimation model will be explained in other embodiments.

Furthermore, in the case illustrated in graph B of FIG. 4, in case the matching score threshold value is raised to TH1, a probability of match failure p2 that the matching score generated by the fourth matching process becomes less than or equal to the matching score threshold value TH1 can be acquired by integrating the occurrence probability h of the matching score s from 0 to the matching score threshold value TH1. Similarly, a probability of match success p1, where the matching score generated by the fourth matching process exceeds the matching score threshold value TH1, can be calculated by integrating the occurrence probability h for cases where the matching score s exceeds the matching score threshold value TH1. Note that in actual calculations, the integral value can be calculated using the trapezoidal rule, which divides an occurrence probability distribution into small intervals, calculates the area of each interval, and sums the areas.

### [2-3: Identity Matching Score/Different Identity Matching Score]

The matching score generated using the biometric information of the same target is referred to as “the identity matching score”. In the case of one-to-N authentication, the biometric information registered includes the biometric information corresponding to the target whose biometric information is acquired by capturing, and the biometric information other than the target. Among individual matching scores generated using the biometric information captured and each piece of the biometric information registered, the matching score generated using the biometric information of the same target can be estimated to be the largest. However, this does not necessarily hold true in cases where a different person is incorrectly matched. In case it is possible to make a determination using other authentication methods or other the biometric information such as multimodal authentication, a determination is made as to whether or not it is an identical person, and the score in case it is determined to be the identical person is called “the identity matching score.” Specifically, during the initial adjustment period after system introduction, it is possible to determine whether or not it is the identical person by using other authentication methods that are not used in normal operation. Alternatively, in cases where there are multiple authentication methods (the authentication methods used for each method may be different) such as in case passing through multiple gates or in case of capturing a person multiple times with multiple cameras, it is possible to integrate matching results of multiple gates to determine whether or not it is the identical person. On the other hand, in case no other authentication means exist, the largest matching score generated from the biometric information captured and the biometric information registered may be regarded as “the identity matching score”.

Additionally, the matching score generated using the biometric information with different target are referred to as “the different identity matching score.” Among the matching score generated using the biometric information captured and the biometric information registered, those generated using the biometric information with different target are estimated to not be the largest, but be the second largest or smaller. However, this also does not hold true in cases where a different person is incorrectly matched. For this reason, as mentioned above, the score determined to be not the identical person is referred to as “the different identity matching score.” On the other hand, in case no other authentication means exist, among each of the matching score generated using the biometric information captured and the biometric information registered, the matching score with the second largest or smaller may be regarded as “the different identity matching score.”

The authentication unit 211 may perform one-to-N authentication. That is, the authentication unit 211 may perform the matching process with N pieces of registered biometric information containing the biometric information of the identical person and the biometric information acquired. The matching score generation unit 2112 may generate N matching scores in single matching process. Hereinafter, among the matching scores generated by the matching score generation unit 2112, the matching score determined to be the identical person (typically the largest matching score) is treated as the identity matching score. Additionally, among the matching scores generated by the matching score generation unit 2112, the largest matching score determined to be a different person (typically the second-largest matching score) is treated as the different identity matching score.

### [2-4: Calculation of False Rejection Probability “P_{f}” Performed by the Information Processing Apparatus 2]

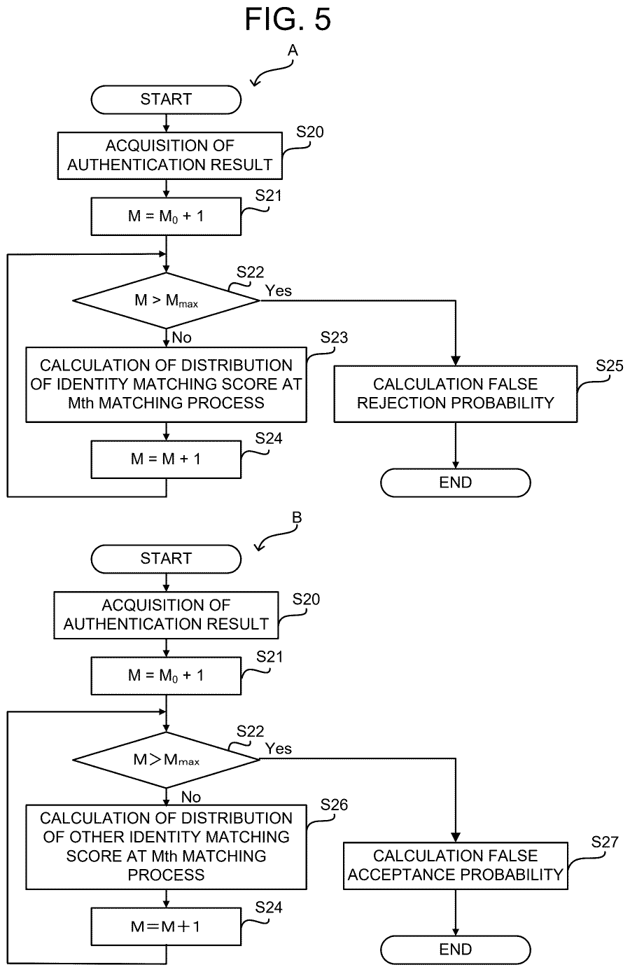

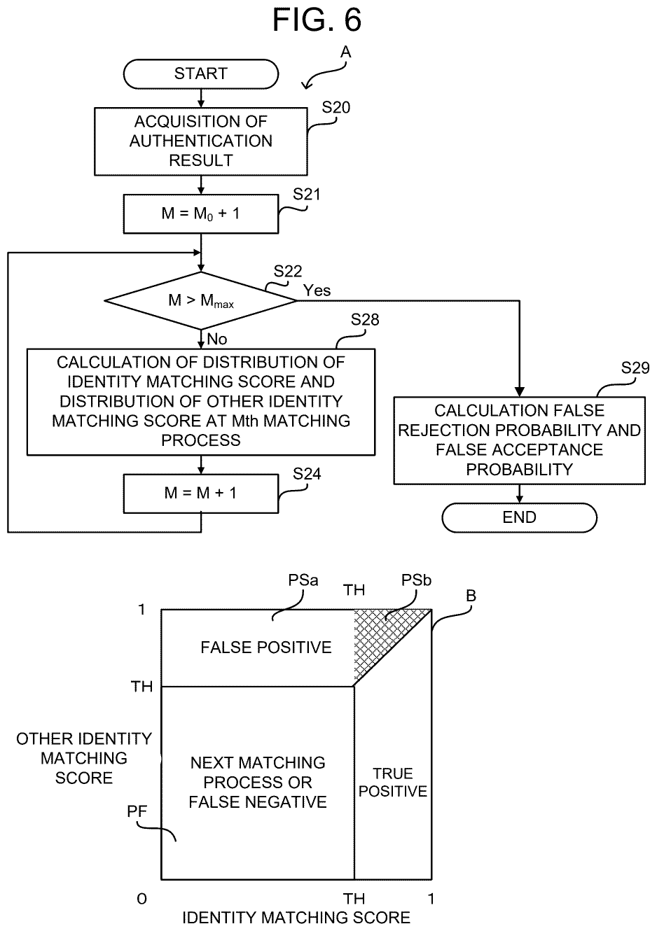

Referring to FIGS. 5 and 6, the flow of the calculation of at least one of a false rejection probability as the estimated authentication information and a false acceptance probability (the probability of incorrect authentication of a different person) performed by the information processing apparatus 2 is described. Flowchart A of FIG. 5 is a flowchart showing the flow of the calculation operation for the false rejection probability performed by the information processing apparatus 2. Flowchart B of FIG. 5 is a flowchart showing the flow of the calculation operation for the false acceptance probability performed by the information processing apparatus 2. Flowchart A of FIG. 6 is a flowchart showing the flow of the calculation operations for the false rejection probability and the false acceptance probability performed by the information processing apparatus 2.

In the flow shown in Flowchart A of FIG. 5, the identity matching score is handled, and the false rejection probability “P_{f}” is calculated in case the upper limit number of times of repetitions is reached. The false rejection probability “P_{f}” indicates the probability of failure of matching with the identical person.

As shown in Flowchart A of FIG. 5, the authentication success/failure probability calculation unit 2121 acquires the authentication result stored in the authentication result storing unit 222 (step S20). The authentication result contains information “M₀” indicating the final time that has ended the repetition of the matching process, and a final identity matching score “s_{M0}”. The distribution of the identity matching score generated in the matching process of the “M₀” th repetitions can be expressed as a delta function as shown in the following equation 1.

$${p}_{self} ( {M}_{0} , s ) = δ ( s - {s}_{{M}_{0}} ) \qquad [ Equation 1 ]$$

The authentication success/failure probability calculation unit 2121 sets “M” to “M₀+1” (step S21). ‘M’ indicates the number of times of repetition of the matching process. Since “M₀” indicates the final time that has ended the repetition of the matching process, “M₀+1” indicates the number of times the next time of the final time has been repeated. For example, in the case illustrated in FIG. 4, “M₀” is “3” and “M₀+1” is “4.”

The authentication success/failure probability calculation unit 2121 determines whether ‘M’ exceeds “Mₘₐₓ” (step S22). “Mₘₐₓ” indicates the upper limit number of times of repetitions.

In case “M” has not exceeded “Mₘₐₓ” (Step S22: No), the authentication success/failure probability calculation unit 2121 calculates the distribution of the identity matching score at the Mth matching process (Step S23).

The conditional occurrence probability of the identity matching score at the next time of the final time “M₀+1” in case the identity matching score at “M₀” is ‘x’ is expressed as “h(s|x).” In this case, the distribution of the identity matching score of the next time of the final time “M₀+1” “P_{self}(M₀+1, s)” may be expressed by the following equation 2. Note that s_{M0} is the Moth identity matching score.

$${p}_{self} ( {M}_{0} + 1 , s ) = {\int }_{0}^{TH} h ( s \vert x ) δ ( x - {s}_{{M}_{0}} ) d x = h ( s \vert {s}_{{M}_{0}} ) \qquad [ Equation 2 ]$$

Therefore, the distribution “P_{self}(M, s)” of the identity matching score of the next time “M₀+1” of the final time and subsequent times may also be expressed by the following Equation 3. That is, the distribution “P_{self}(M, s)” of the identity matching score the next time “M₀+1” of the final time and subsequent times may be calculated from the occurrence probability distribution of the matching score where the identity matching score of the previous time “M−1” before the “M” is less than or equal to the matching score threshold value TH, and the conditional occurrence probability distribution of the matching score of next time corresponding to that matching score. In step S23, the distribution “P_{self}(M, s)” of the identity matching score may be calculated using the following equation 3.

$${p}_{self} ( M , s ) = {\int }_{0}^{TH} h ( s \vert x ) {p}_{self} ( M - 1 , x ) dx \qquad [ Equation 3 ]$$

Here, the conditional occurrence probability distribution h(s|x) is calculated in advance as the occurrence probability estimation model of the identity matching score and stored as described below. Note that here, the occurrence probability distribution is assumed to depend only on the identity matching score of the previous time, but a model that depends on the identity matching score prior to the previous time may also be used. For example, instead of the identity matching score of the previous time, the model may depend on a statistical representative value (such as the average or median) of the identity matching score prior to the previous time.

The authentication success/failure probability calculation unit 2121 increments “M” by “1” (step S24). Each time the authentication success/failure probability calculation unit 2121 increments ‘M’ by “1,” it calculates the distribution of the identity matching score expressed by the above equation 3.

In case “M” exceeds “Mₘₐₓ” (step S22: Yes), the authentication success/failure probability calculation unit 2121 calculates the false rejection probability (step S25). The authentication success/failure probability calculation unit 2121 may calculate the false rejection probability from the distribution of the identity matching score “P_{self}(Mₘₐₓ, S)” in case the number of times of repetitions ‘M’ is the upper limit number of times of repetitions “Mₘₐₓ”. The authentication success/failure probability calculation unit 2121 can calculate the false rejection probability by repeating the process expressed by the above equation 3 “Mₘₐₓ-M₀” times. The false rejection probability is the probability that authentication fails even in case the upper limit number of times of repetitions “Mₘₐₓ” is reached and the identity matching score does not exceed the matching score threshold value TH. The false rejection probability “P_{f}” may also be expressed by the following equation 4.

$${P}_{f} = {\int }_{0}^{TH} {p}_{self} ( {M}_{max} , s ) ds \qquad [ Equation 4 ]$$

That is, the authentication success/failure probability calculation unit 2121 can estimate the false rejection probability “P_{f},” which indicates the probability of failure of matching with the identical person in case the authentication success/failure probability calculation unit 2121 is repeated the matching process times up to the predetermined number of times at a predetermined threshold value of the identity matching score using the occurrence probability.

### [2-5: Calculation of the False Acceptance Probability “Pₛ” Performed by the Information Processing Apparatus 2]

In the flowchart B shown in FIG. 5, the different identity matching score is handled, and the false acceptance probability “Pₛ” is calculated in case the upper limit number of times of repetitions is reached. The false acceptance probability “Pₛ” indicates the probability of success in matching with a different person other than the identical person.

As shown in flowchart B in FIG. 5, the authentication success/failure probability calculation unit 2121 acquires the authentication result stored in the authentication result storing unit 222 (step S20). The authentication result contains information indicating the final time “M₀” that has ended the repetition of the matching process, and the final different identity matching score “t_{M0}”. The distribution of the different identity matching score generated in the matching process of the “M₀” th time can be expressed by a delta function as shown in the following equation 5.

$${p}_{other} ( {M}_{0} , t ) = δ ( t - {t}_{{M}_{0}} ) \qquad [ Equation 5 ]$$

The authentication success/failure probability calculation unit 2121 sets ‘M’ to “M₀+1” (step S21). Since “M₀” indicates the final time that has ended the repetition of the matching process, “M₀+1” indicates the next time of the final time.

In case ‘M’ has not exceeded “Mₘₐₓ” (step S22: No), the authentication success/failure probability calculation unit 2121 calculates the distribution of the different identity matching score at the Mth matching process (step S26).

In case expressing the occurrence probability of the different identity matching score as “g(t)”, the distribution “Pₒₜₕₑᵣ(M₀+1, t)” of the different identity matching score at the next time “M₀+1” of the final time can be expressed by the following equation 6. In this embodiment, it is assumed that the occurrence probability g of the different identity matching score does not depend on the different identity matching score “y” of the previous time (g(t|y)=g(t)).

$${p}_{other} ( {M}_{0} + 1 , r ) = g ( t ) {\int }_{0}^{TH} δ ( y - {t}_{{M}_{0}} ) dy = g ( t ) \qquad [ Equation 6 ]$$

Therefore, the distribution “Pₒₜₕₑᵣ(M, t)” of the different identity matching score for the next time “M₀+1” of the final time and subsequent times can be expressed using the following Equation 7. That is, the distribution “Pₒₜₕₑᵣ(M, t)” of the different identity matching score for the next time “M₀+1” of the final time and “M₀+1” can be calculated from the probability that the different identity matching score at the previous time “M−1” is less than or equal to the matching score threshold value TH and the occurrence probability distribution of the matching score of the next time. In step S26, the distribution “Pₒₜₕₑᵣ(M, t)” of the different identity matching score may be calculated using the following equation 7.

$${p}_{other} ( M , s ) = g ( s ) {\int }_{0}^{TH} {p}_{other} ( M - 1 , x ) dx \qquad [ Equation 7 ]$$

Here, the occurrence probability distribution g(t) is calculated in advance as the occurrence probability estimation model of the different identity matching score and stored as described later. Note that here, the occurrence probability distribution is assumed to be independent of the different identity matching score of the previous time, but it may also be determined depending on the different identity matching score of the previous time, similar to the case of the identity matching score. In that case, the same occurrence probability estimation model as for the identity matching score should be generated and stored for use. Additionally, a model that depends on the different identity matching score prior to the previous time may also be used.

The authentication success/failure probability calculation unit 2121 increments “M” by “1” (step S24). Each time the authentication success/failure probability calculation unit 2121 increments ‘M’ by “1,” it calculates the distribution of the different identity matching score expressed by the above equation 7.

In case “M” exceeds “Mₘₐₓ” (step S22: Yes), the authentication success/failure probability calculation unit 2121 calculates the false acceptance probability (step S27). The authentication success/failure probability calculation unit 2121 may calculate the false acceptance probability using the distribution of the different identity matching score “Pₒₜₕₑᵣ(M, t)” from repeat times “M₀+1” to “Mₘₐₓ”. The authentication success/failure probability calculation unit 2121 may calculate the false acceptance probability by summing the probabilities that the different identity matching score reaches or exceeds the matching score threshold value TH at each repeat times. The authentication success/failure probability calculation unit 2121 may calculate the false acceptance probability by repeating the process expressed by the above equation 7 “Mₘₐₓ-M₀” times. The false acceptance probability is the probability that the different identity matching score exceeds the matching score threshold value TH and a different person acceptance occurs before the upper limit number of times of repetitions “Mₘₐₓ” is reached. The false acceptance probability “Pₛ” may be expressed by the following equation 8.

$${P}_{s} = {\sum }_{M = {M}_{0} + 1}^{{M}_{max}} ( {\int }_{TH}^{1} {p}_{other} ( M , s ) ds ) \qquad [ Equation 8 ]$$

That is, the authentication success/failure probability calculation unit 2121 uses the occurrence probability to estimate the false acceptance probability “Pₛ,” which indicates the probability of successfully matching with a different person other than the identical person in case the authentication unit 211 repeats the matching process up to the predetermined number of times for the predetermined threshold value of the different identity matching score.

### [2-6: Calculation of the False Rejection Probability and the False Acceptance Probability Performed by the Information Processing Apparatus 2]

Next, the calculation operation in case considering the rejection of the identical person and the acceptance of a different person together at the matching process is explained. In the flowchart A of FIG. 6, the identity matching score and the different identity matching score are handled, and the false rejection probability and the false acceptance probability are calculated in case reaching the upper limit number of times of repetitions.

As shown in flowchart A in FIG. 6, the authentication success/failure probability calculation unit 2121 acquires the authentication result stored in the authentication result storing unit 222 (step S20). The distribution of the identity matching score generated in the Moth matching process and the distribution of the different identity matching score can be formulated as in the following equation 9.

$$p ( {M}_{0} , s , t ) = δ ( s - {s}_{{M}_{0}} ) δ ( t - {t}_{{M}_{0}} ) \qquad [ Equation 9 ]$$

The authentication success/failure probability calculation unit 2121 sets “M” to “M₀+1” (step S21). In case ‘M’ does not exceed “Mₘₐₓ” (step S22: No), the authentication success/failure probability calculation unit 2121 calculates the distribution of the identity matching score and the distribution of the different identity matching score at the Mth matching process (step S28).

The distribution of the identity matching score and the different identity matching score for the next time “M₀+1” of the final time can also be formulated as shown in the following equation 10.

$$p ( {M}_{0} + 1 , s , t ) = {\int }_{0}^{TH} {\int }_{0}^{TH} h ( s \vert x ) g ( t ) δ ( x - {s}_{{M}_{0}} ) δ ( y - {t}_{{M}_{0}} ) dxdy = h ( s \vert {s}_{{M}_{0}} ) g ( t ) \qquad [ Equation 10 ]$$

The distribution of the identity matching score and the different identity matching score for the next time “M₀+1” of the final time and subsequent times can also be formulated as shown in the following equation 11.

$$p ( M , s , t ) = {\int }_{0}^{TH} {\int }_{0}^{TH} h ( s \vert x ) g ( t ) p ( M - 1 , x , y ) dxdy \qquad [ Equation 11 ]$$

The authentication success/failure probability calculation unit 2121 increments “M” by “1” (Step S24). The authentication success/failure probability calculation unit 2121 calculates the distribution of the identity matching score and the distribution of the different identity matching score expressed by the above Equation 11 each time ‘M’ is incremented by “1.” In case “M” exceeds “Mₘₐₓ” (step S22: Yes), the authentication success/failure probability calculation unit 2121 calculates the false rejection probability and the false acceptance probability (step S29).

In case considering the rejection of the identical person and the acceptance of a different person together, the false rejection probability “P_{f}” may be expressed as shown in the following equation 12.

$${P}_{f} = {\int }_{0}^{TH} {\int }_{0}^{TH} p ( {M}_{max} , s , t ) dsdt \qquad [ Equation 12 ]$$

That is, the false rejection probability “P_{f}” may be expressed as the probability that both the identity matching score and the different identity matching score do not exceed the matching score threshold value TH in case repeated up to the upper limit number of times of repetitions.

Furthermore, the false acceptance probability “Pₛ” in case considering the rejection of the identical person and the acceptance of a different person together may be expressed as follows in Equation 13.

$${P}_{s} = {\sum }_{M = {M}_{0} + 1}^{{M}_{max}} ( {\int }_{TH}^{1} ( {\int }_{0}^{TH} p ( M , s , t ) ds ) dt + {\int }_{TH}^{1} ( {\int }_{TH}^{t} p ( M , s , t ) ds ) dt ) \qquad [ Equation 13 ]$$

The false acceptance probability “Pₛ” may be expressed as the sum of a probability that the different identity matching score exceeds the matching score threshold value and the identity matching score does not exceed the matching score threshold value, and a probability that the different identity matching score exceeds the matching score threshold value and the identity matching score exceeds the matching score threshold value but is smaller than the different identity matching score.

Block B in FIG. 6 is a conceptual diagram that considers the rejection of the identical person and the acceptance of a different person together. The false rejection probability can be expressed as the region PF where both the identity matching score and the different identity matching score do not exceed the matching score threshold value TH. The false acceptance probability can be expressed as region PSa, where the different identity matching score exceeds the matching score threshold value and the identity matching score does not exceed the matching score threshold value, and region PSb, where the different identity matching score exceeds the matching score threshold value and the identity matching score exceeds the matching score threshold value but is smaller than the different identity matching score.

Note that even in case it is possible to detect that the identical person has been rejected, it may be difficult to detect that a different person has been accepted. In such cases, there may be situations where both the identity matching score and the different identity matching score can be used, or where only one of them can be used. In cases where only one can be used, calculate one of them as explained with reference to FIG. 5.

The output control unit 213 outputs at least one of the false rejection probability “P_{f}” and the false acceptance probability “Pₛ” in case the matching process is repeated up to the predetermined number of times for the predetermined threshold value of the matching score. Additionally, the output control unit 213 may display information that visually clarifies the possible values of the matching score and its corresponding the occurrence probability in case the matching score threshold value is changed from TH0 to TH1, as illustrated in Graph B of FIG. 4, and further the matching process is repeated, on the display as output apparatus 25.

Furthermore, the information processing apparatus 2 may determine the optimal the upper limit number of times of repetitions “Mₘₐₓ” based on the variation of the matching score for each repetition.

Note that the authentication unit 211 may not include the acquisition unit 2111 and the matching score generation unit 2112. That is, the authentication unit 211 may be a mechanism that performs the matching process to determine the success or failure of authentication of the target based on the matching score and the predetermined conditions. In this case, the authentication unit 211 acquires the matching score from an external mechanism. The external mechanism corresponds to the acquisition unit 2111 and the matching score generation unit 2112.

### [2-7: Technical Effects of the Information Processing Apparatus 2]

In the second embodiment, the information processing apparatus 2 calculates the occurrence probability of the matching score generated in case the matching process is performed after the final time according to the final matching score, so that information on the success or failure of authentication of the target in case the matching process is repeated until the predetermined number of times can be estimated accurately. The information processing apparatus 2 uses the occurrence probability, so it can accurately estimate at least one of the false rejection probability and the false acceptance probability in case the matching process is repeated until the predetermined number of times for the predetermined threshold value of the matching score. Additionally, the information processing apparatus 2 ends the repetition of the matching process in case the matching score exceeds the corresponding the matching score threshold value, thereby suppressing unnecessary the matching process operations.

### 3: Third Example Embodiment

Next, the third embodiment of the information processing apparatus, information processing method, and recording medium will be described. In the following, the third embodiment of the information processing apparatus, information processing method, and recording medium will be described using an information processing apparatus 3 to which the third embodiment of the information processing apparatus, information processing method, and recording medium is applied.

### [3-1: Configuration of the Information Processing Apparatus 3]

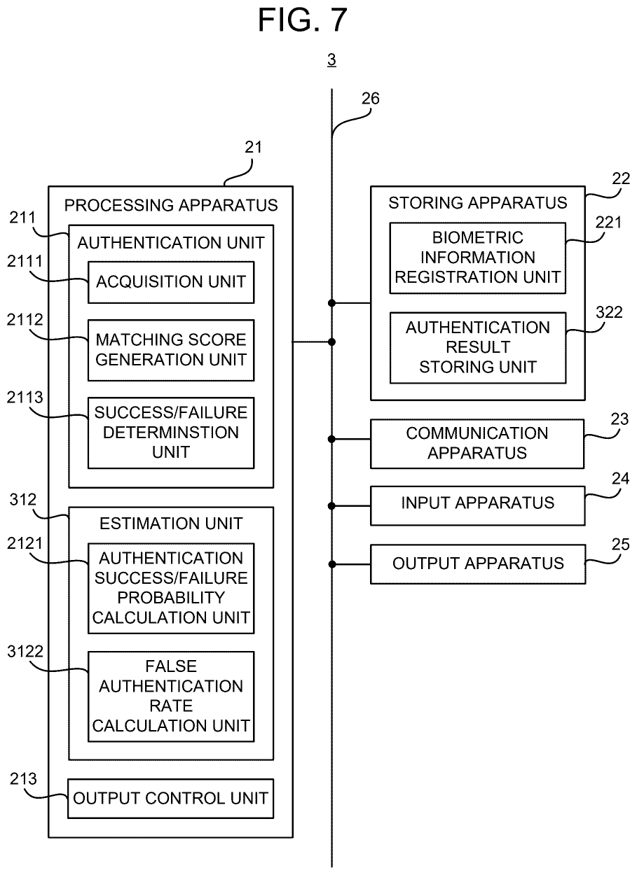

Referring to FIG. 7, the configuration of the information processing apparatus 3 according to the third embodiment will be described. FIG. 7 is a block diagram showing the configuration of the information processing apparatus 3 according to the third embodiment.

As shown in FIG. 7, the information processing apparatus 3 according to the third embodiment differs from the information processing apparatus 2 according to the second embodiment in that an estimation unit 312 includes a false authentication rate calculation unit 3122. The other features of the information processing apparatus 3 may be the same as those of the information processing apparatus 2. Therefore, in the following, in detail only the parts that differ from the previously described embodiments will be described, and the description of other redundant parts as appropriate will be omitted.

The false authentication rate calculation unit 3122 performs at least one of an operation of estimating the false negative identification-error rate (FNIR, hereinafter referred to simply as false negative error rate) of incorrectly rejecting of the identity person by using the false rejection probability for each the authentication operation described in the second embodiment, and an operation of estimating the false positive identification-error rate (FPIR, hereinafter referred to as false positive error rate) of incorrectly accepting of a different person by using the false acceptance probability for each the authentication operation described in the second embodiment, with respect to the predetermined threshold value of the matching score. The false authentication rate calculation unit 3122 sets the predetermined threshold value to a desired value. The predetermined threshold value may be set to a value greater than the matching score threshold value used in past matching process.

An authentication result storing unit 322 may store results of K past authentication operation (a series of the matching process repetitions within the upper limit number of times of repetitions for the same the target). The K past authentication result may be the results of authentication for a total of K people. In other words, the K past authentication result may include the authentication result for the same person. Furthermore, each the authentication result contained in the K past authentication result may be the authentication result of a different person.

Each the authentication result contains information indicating the final time, as well as the first and second largest final matching score among the identity matching score and the different identity matching score in the final time, which are used as the identity matching score and the different identity matching score, respectively. The identity matching score in the final time is referred to as “the final identity matching score.” The different identity matching score in the final time is referred to as “the final different identity matching score.”

### [3-2: Calculation of the False Negative Error Rate Performed by the Information Processing Apparatus 3]

The number of times false rejection “S_{f}” in this embodiment is the number of times acquired by adding together the false rejection probability P_{f} that fail authentication even in case the matching process is repeated up to the upper limit number of times of repetitions among the K authentication operation. Since the number of times false rejection “S_{f}” is the number of times acquired by adding together probabilistically calculated values, it is not necessarily an integer and is usually decimal number.

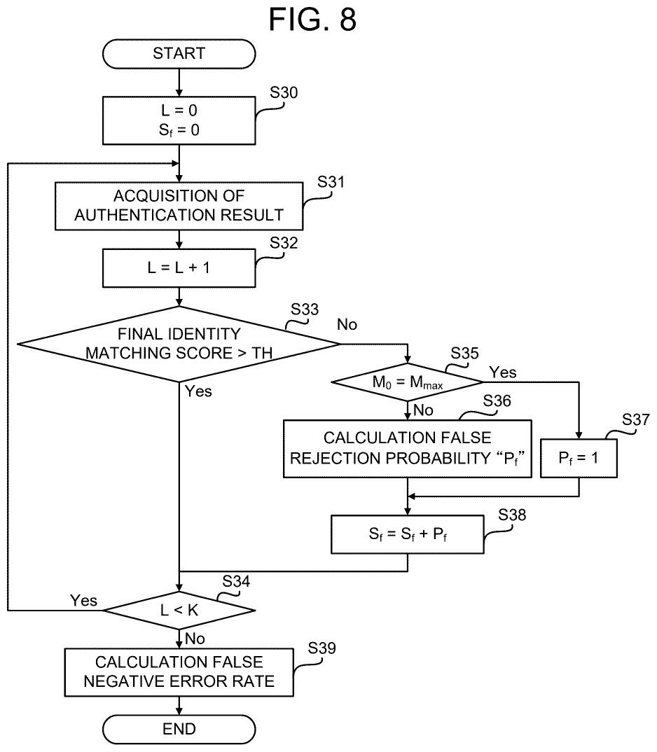

As shown in FIG. 8, the false authentication rate calculation unit 3122 sets “L” and the number of times false rejection “S_{f}” to “0” (step S30). The false authentication rate calculation unit 3122 acquires the past authentication result from the authentication result storing unit 322 (step S31). An estimation unit 312 increments ‘L’ by “1” (step S32).

The false authentication rate calculation unit 3122 determines whether the number of the final identity matching score contained in the past authentication result exceeds the predetermined threshold value (step S33). In case the final identity matching score exceeds the predetermined threshold value (step S33: Yes), it determines whether L is less than K (step S34). In other words, it determines whether there is any unprocessed past authentication result among the K past authentication result. In case there are unprocessed past authentication result (Step S34: Yes), return to Step S31 and perform processing using the unprocessed past authentication result.

The final identity matching score does not exceed the predetermined threshold value (Step S33: No), the false authentication rate calculation unit 3122 determines whether “M₀” is “Mₘₐₓ” (Step S35). In case “M₀” is not “Mₘₐₓ” (Step S35: No), the authentication success/failure probability calculation unit 2121 calculates the false rejection probability P_{f} in case the matching process at the upper limit number of times of repetitions is performed, as described with reference to the flowchart A in FIG. 5 (Step S36). In case “M₀” is “Mₘₐₓ” (step S35: Yes), the false authentication rate calculation unit 3122 sets “P_{f}” to “1” (step S37).

The false authentication rate calculation unit 3122 adds “P_{f}” to “S_{f}” (step S38). In case there are unprocessed past authentication result among the K past authentication result (step S34: Yes), return to step S31 and perform processing using the unprocessed past authentication result. In case there are no unprocessed past authentication result (Step S34: No), the false authentication rate calculation unit 3122 calculates the false negative error rate that incorrectly rejects the identical person corresponding to the predetermined threshold value (Step S39). The false authentication rate calculation unit 3122 calculates the false negative error rate by dividing the number of times false rejection “S” by “K”.

In other words, the false authentication rate calculation unit 3122 can estimate the false negative error rate that incorrectly rejects the identical person corresponding to the predetermined threshold value of the matching score using the false rejection probability.

### [3-3: Calculation Operation of the False Positive Error Rate Performed by the Information Processing Apparatus 3]

The number of times false acceptance “Oₛ” according to this embodiment is the number acquired by summing the number of times the final different identity matching score exceeds the predetermined threshold value and the probability that the different identity matching score exceeds the predetermined threshold value before the matching process is repeated up to the upper limit number of times of repetitions in case the final different identity matching score does not exceed the predetermined threshold value, for the K authentication operation. Note that the number of times false acceptance “Oₛ” is not necessarily an integer and is typically decimal number.

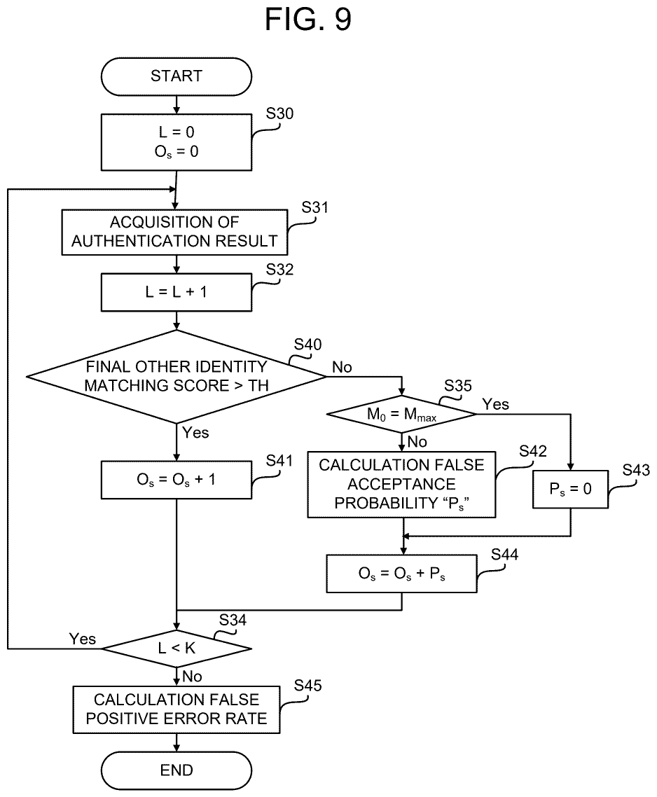

As shown in FIG. 9, the false authentication rate calculation unit 3122 sets “L” and the number of times false acceptance “Oₛ” to “0” (step S30). The false authentication rate calculation unit 3122 acquires the past authentication result from the authentication result storing unit 322 (step S31). The false authentication rate calculation unit 3122 increments ‘L’ by “1” (step S32).

The false authentication rate calculation unit 3122 determines whether the final different identity matching score contained in the past authentication result exceeds the predetermined threshold value (step S40). In case the final different identity matching score exceeds the predetermined threshold value (step S40: Yes), the false authentication rate calculation unit 3122 increments the number of times false acceptance “Oₛ” to “1” (step S41).

In case the final different identity matching score does not exceed the predetermined threshold value (step S40: No), the false authentication rate calculation unit 3122 determines whether “M₀” is equal to “Mₘₐₓ” (step S35). In case “M₀” is not “Mₘₐₓ” (Step S35: No), the authentication success/failure probability calculation unit 2121 calculates the false acceptance probability Pₛ corresponding to the matching process of the upper limit number of times of repetitions as described in the flowchart B of FIG. 5 (Step S42). In case “M₀” is “Mₘₐₓ” (step S35: Yes), the false authentication rate calculation unit 3122 sets “Pₛ” to “0” (step S43).

The false authentication rate calculation unit 3122 adds “Pₛ” to “Oₛ” (step S44). The false authentication rate calculation unit 3122 determines whether L is less than K (step S34). In case L is less than K (step S34: Yes), return to step S31 and perform processing using the unprocessed past authentication result. In case there are no unprocessed past authentication result (Step S34: No), the false authentication rate calculation unit 3122 calculates the false positive error rate that incorrectly accepts a different person corresponding to the predetermined threshold value of the matching score (Step S45). The false authentication rate calculation unit 3122 calculates the false positive error rate by dividing the number of times false acceptance “Oₛ” by “K”.

In other words, the false authentication rate calculation unit 3122 can estimate the false positive error rate, which incorrectly accepts a different person, corresponding to the predetermined threshold value of the matching score using the false acceptance probability.

### [3-4: Calculation of the False Negative Error Rate and the False Positive Error Rate Performed by the Information Processing Apparatus 3]

Next, the calculation operation in case considering the rejection of the identical person and the acceptance of a different person together during the matching process will be described.

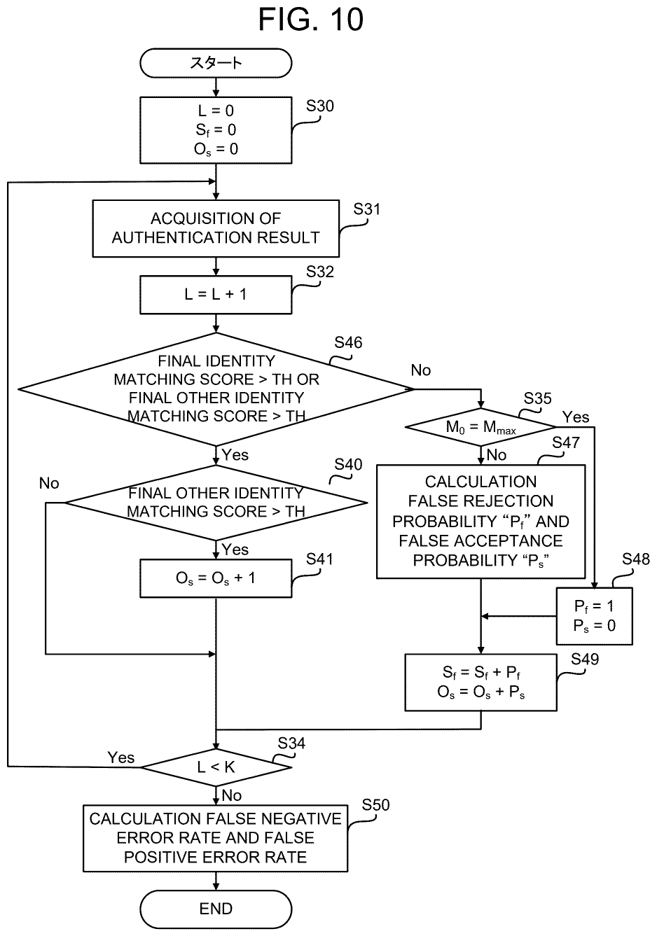

As shown in FIG. 10, the false authentication rate calculation unit 3122 sets “L,” the number of times false rejection “S_{f},” and the number of times false acceptance “Oₛ” to “0” (step S30). The false authentication rate calculation unit 3122 acquires the past authentication result from the authentication result storing unit 322 (step S31). The false authentication rate calculation unit 3122 increments “L” by 1 (step S32).

The false authentication rate calculation unit 3122 determines whether the final identity matching score contained in the past authentication result exceeds the predetermined threshold value or whether the final different identity matching score exceeds the predetermined threshold value (step S46). In case the final identity matching score exceeds the predetermined threshold value or the final different identity matching score exceeds the predetermined threshold value (step S46: Yes), the false authentication rate calculation unit 3122 determines whether the final different identity matching score exceeds the predetermined threshold value (step S40). In case the final different identity matching score exceeds the predetermined threshold value (Step S40: Yes), the false authentication rate calculation unit 3122 increments the number of times false acceptance “Oₛ” by “1” (Step S41).

In case the final identity matching score does not exceed the predetermined threshold value and the final different identity matching score also does not exceed the predetermined threshold value (Step S46: No), the false authentication rate calculation unit 3122 determines whether “M₀” is “Mₘₐₓ” (Step S35). In case “M₀” is not “Mₘₐₓ” (Step S35: No), calculate the false rejection probability and the false acceptance probability for the matching process of the upper limit number of times of repetitions as described in the flowchart A of FIG. 6 (Step S47). In case “M₀” is “Mₘₐₓ” (step S35: Yes), the false authentication rate calculation unit 3122 sets “P_{f}” to “1” and “Pₛ” to ‘0’ (step S48).

The false authentication rate calculation unit 3122 adds “P_{f}” to “S”. Additionally, the false authentication rate calculation unit 3122 adds “Pₛ” to “Oₛ” in the number of times false acceptance (Step S49). The false authentication rate calculation unit 3122 determines whether L is less than K (Step S34). In case L is less than K (Step S34: Yes), return to Step S31 and perform processing using the unprocessed past authentication result. In case there are no unprocessed past authentication result (step S34: No), the false authentication rate calculation unit 3122 calculates the false negative error rate and the false positive error rate corresponding to the predetermined threshold value of the matching score (step S50). The false authentication rate calculation unit 3122 calculates the false negative error rate by dividing the number of times false rejection “Sr” by “K,” and calculates the false positive error rate by dividing the number of times false acceptance “Oₛ” by “K.”

The output control unit 213 may output at least one of the estimated values of the false negative error rate and the false positive error rate corresponding to the predetermined threshold value of the matching score via the output apparatus 25.

### [3-5: Technical Effects of the Information Processing Apparatus 3]

The information processing apparatus 3 according to the third embodiment can accurately estimate the false negative error rate corresponding to the matching score threshold value based on the false rejection probability. The information processing apparatus 3 can accurately estimate the false positive error rate corresponding to the matching score threshold value based on the false acceptance probability.

### 4: Fourth Example Embodiment

Next, the fourth embodiment of the information processing apparatus, information processing method, and recording medium will be described. In the following, the fourth embodiment of the information processing apparatus, information processing method, and recording medium will be described using an information processing apparatus 4 to which the fourth embodiment of the information processing apparatus, information processing method, and recording medium is applied.

### [4-1: Configuration of the Information Processing Apparatus 4]

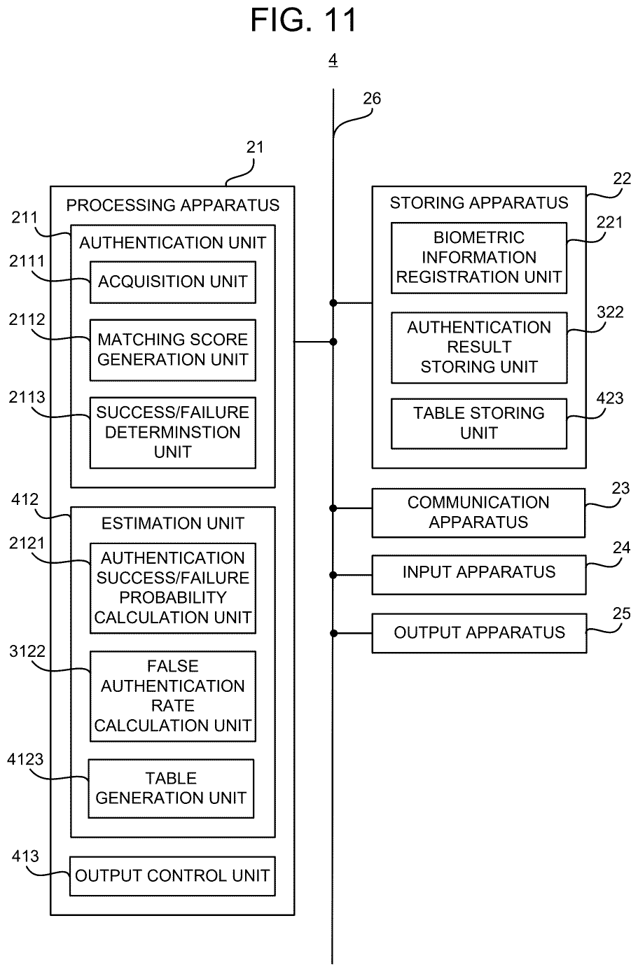

Referring to FIG. 11, the configuration of the information processing apparatus 4 according to the fourth embodiment will be described. FIG. 11 is a block diagram showing the configuration of the information processing apparatus 4 according to the fourth embodiment.

As shown in FIG. 11, the information processing apparatus 4 according to the fourth embodiment differs from the information processing apparatus 2 according to the second embodiment and the information processing apparatus 3 according to the third embodiment in that it includes an estimation unit 412 containing a table generation unit 4123 and realizes a table storing unit 423 within the storing apparatus 22. Other features of the information processing apparatus 4 may be the same as those of at least one of the information processing apparatus 2 and the information processing apparatus 3. Therefore, the following description will focus on the parts that differ from the previously described embodiments, and the redundant parts will be omitted as appropriate.

### [4-2: Calculation of at Least One of the False Negative Error Rate and the False Positive Error Rate for Each the Matching Score Threshold Value Performed by the Information Processing Apparatus 4]

The table generation unit 4123 gradually changes the matching score threshold value TH and, for each the matching score threshold value changed, estimates at least one of the false negative error rate that incorrectly rejects the identical person and the false positive error rate that incorrectly accepts a different person.

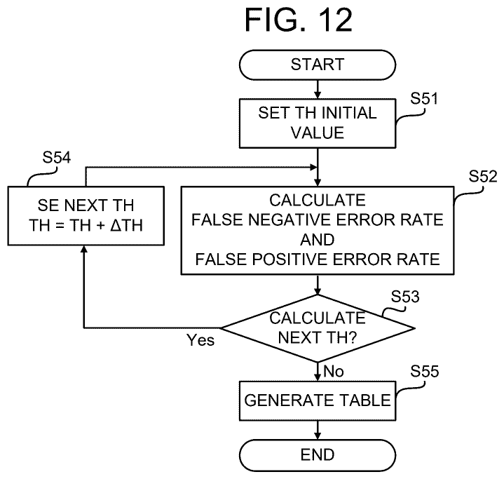

Referring to FIG. 12, the flow of the calculation operation for at least one of the false negative error rate and the false positive error rate performed by the information processing apparatus 4 for each the matching score threshold value is described. FIG. 12 is a flowchart showing the flow of the calculation operation for at least one of the false negative error rate and the false positive error rate performed by the information processing apparatus 4 for each the matching score threshold value.

As shown in FIG. 12, the table generation unit 4123 sets the matching score threshold value TH to an initial value (step S51). The table generation unit 4123 may set the minimum value of the matching score threshold value that may be used during operation as the initial value for the matching score threshold value TH.

The false authentication rate calculation unit 3122 calculates at least one of the false negative error rate and the false positive error rate corresponding to set matching score threshold value TH (step S52). The false authentication rate calculation unit 3122 may perform at least one of the operations described with reference to FIG. 8 to FIG. 10 and calculate at least one of the false negative error rate and the false positive error rate.

The table generation unit 4123 determines whether to calculate at least one of the false negative error rate and the false positive error rate corresponding to next matching score threshold value TH (step S53). The table generation unit 4123 may determine whether to calculate at least one of the false negative error rate and the false positive error rate for the next matching score threshold value TH that is greater than the currently set matching score threshold value TH by a predetermined change amount ΔTH. The table generation unit 4123 may determine that at least one of the false negative error rate and the false positive error rate corresponding to the next matching score threshold value TH is calculated in case the next matching score threshold value TH is less than the maximum value of the matching score threshold value that may be used during operation. In case it is determined that at least one of the false negative error rate and the false positive error rate corresponding to the next matching score threshold value TH should be calculated (step S53: Yes), the table generation unit 4123 sets the next matching score threshold value TH (step S54) and proceeds to step S51.

In case neither the false negative error rate nor the false positive error rate corresponding to the next matching score threshold value TH is calculated (step S55: No), the table generation unit 4123 generates a table containing the matching score threshold value TH and at least one of the false negative error rate and the false positive error rate corresponding to the matching score threshold value TH (step S51). The table generation unit 4123 stores the generated table in the table storing unit 423.

### [4-3: Output Operation Performed by the Information Processing Apparatus 4]

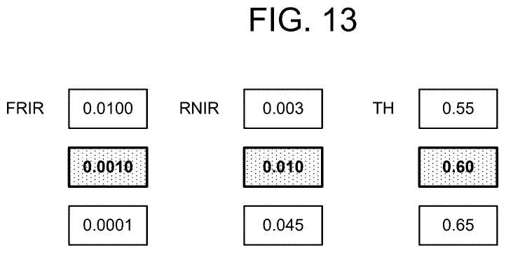

In case one of the false negative error rate and the false positive error rate is specified, an output control unit 413 refers to the table stored in the table storing unit 423 and outputs other of the false negative error rate and the false positive error rate. As illustrated in FIG. 13, the output control unit 413 may display the other of the false negative error rate and the false positive error rate on the display as the output apparatus in case either the false negative error rate or the false positive error rate is specified. The output control unit 413 may display the matching score threshold value TH corresponding to the false negative error rate or the false positive error rate specified.

For example, in case the user setting the matching score threshold value TH specifies at least one of desired false negative error rate and desired false positive error rate, the output control unit 413 may display a combination of the false negative error rate, the false positive error rate, and the matching score threshold value TH whose values are close to at least one of the desired false negative error rate and the desired false positive error rate. The output control unit 413 may highlight combinations of the false negative error rate, the false positive error rate, and the matching score threshold value TH that are determined to be particularly appropriate, as illustrated in FIG. 13.

### [4-4: Technical Effects of the Information Processing Apparatus 4]

The information processing apparatus 4 according to the fourth embodiment can accurately estimate the corresponding false negative error rate and false positive error rate for each the matching score threshold value TH. The information processing apparatus 4 can support the setting of appropriate matching score threshold value TH corresponding to the desired false negative error rate and the desired false positive error rate.

### 5: Fifth Example Embodiment

Next, the fifth embodiment of the information processing apparatus, information processing method, and recording medium will be described. In the following, the fifth embodiment of the information processing apparatus, information processing method, and recording medium will be described using an information processing apparatus 5 to which the fifth embodiment of the information processing apparatus, information processing method, and recording medium is applied.

### [5-1: Configuration of the Information Processing Apparatus 5]

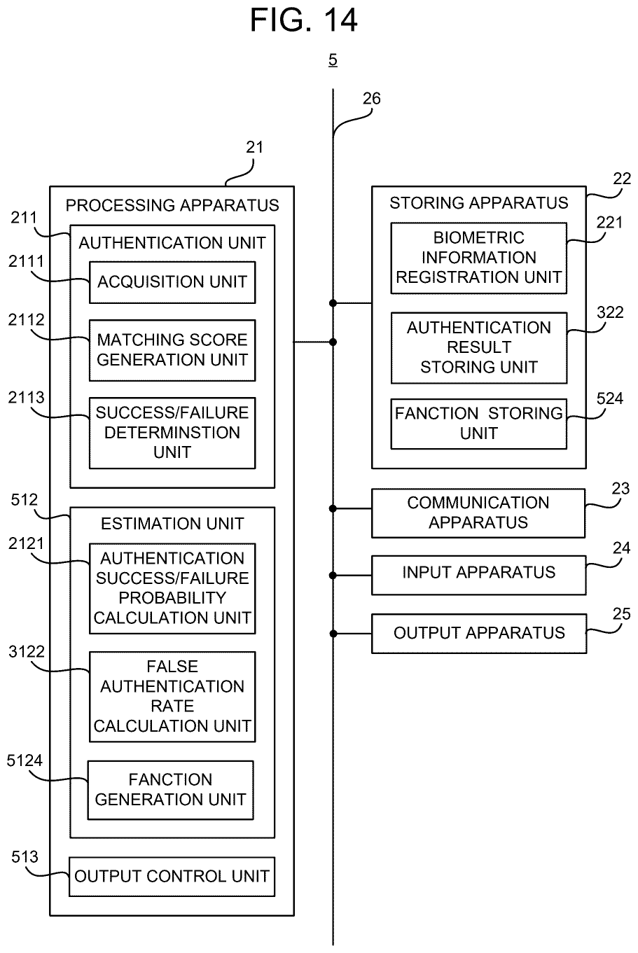

Referring to FIG. 14, the configuration of the information processing apparatus 5 according to the fifth embodiment will be described. FIG. 14 is a block diagram showing the configuration of the information processing apparatus 5 according to the fifth embodiment.

As shown in FIG. 14, the information processing apparatus 5 according to the fifth embodiment differs from the information processing apparatus 2 according to the second embodiment through the information processing apparatus 4 according to the fourth embodiment in that an estimation unit 512 includes a function generation unit 5124 and realizes a function storing unit 524 within the storing apparatus 22. Other features of the information processing apparatus 5 may be the same as at least one other feature of the information processing apparatus 2 through the information processing apparatus 4. Therefore, the following description will focus on the parts that differ from the previously described embodiments, and the redundant parts will be omitted as appropriate.

### [5-2: Function Generation Operation Performed by the Information Processing Apparatus 5]

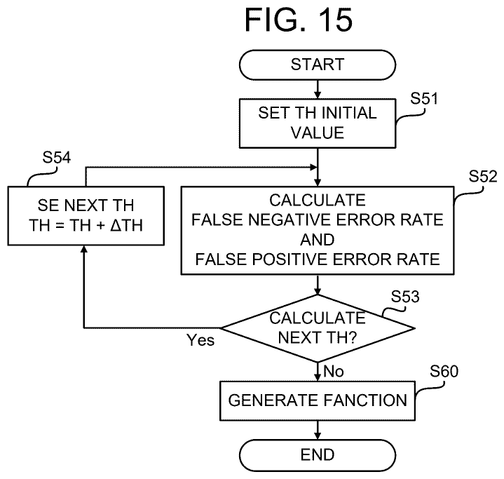

Referring to FIG. 15, the flow of the function generation operation performed by the information processing apparatus 5 will be described. FIG. 15 is a flowchart showing the flow of the function generation operation performed by the information processing apparatus 5.

As shown in FIG. 15, the function generation unit 5124 sets the matching score threshold value TH to an initial value (step S51). The false authentication rate calculation unit 3122 calculates at least one of the false negative error rate and the false positive error rate corresponding to the set matching score threshold value TH (step S52). In case a calculation of at least one of the false negative error rate and the false positive error rate corresponding to the next matching score threshold value TH is performed (Step S53: Yes), the function generation unit 5124 sets the next matching score threshold value TH (Step S54) and returns to Step S51.

In case the calculation of at least one of the false negative error rate and the false positive error rate corresponding to the next matching score threshold value TH is not performed (step S53: No), the function generation unit 5124 generates a function of at least one of the false negative error rate and the false positive error rate corresponding to the matching score threshold value TH (step S60). The function generation unit 5124 may derive a function from the discrete values of the matching score threshold value TH and at least one of the false negative error rate and the false positive error rate corresponding to the matching score threshold value TH.

### [5-3: Output Operation Performed by the Information Processing Apparatus 5]

An output control unit 513 outputs at least one of the false negative error rate and the false positive error rate as a function of the matching score threshold value TH. The output control unit 513 may control an output of a graph of the function generated by the function generation unit 5124.

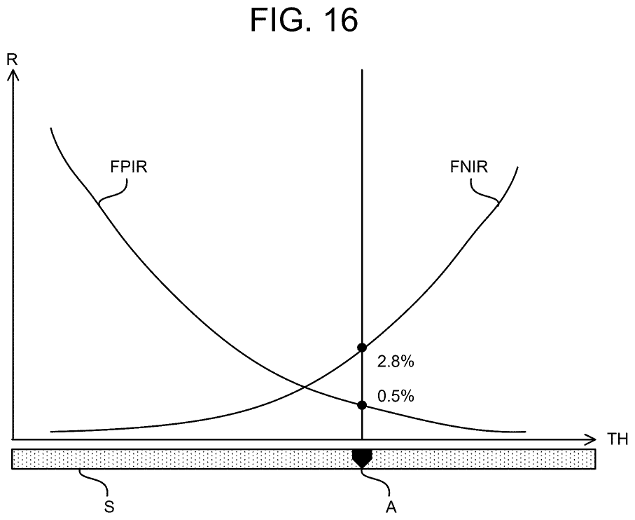

For example, the output control unit 513 may display a graph on a display as the output apparatus 25, where the horizontal axis represents the matching score threshold value TH and the vertical axis represents the false negative error rate FNIR and the false positive error rate FPIR, as shown in FIG. 16.

Additionally, the output control unit 513 may output at least one of the false negative error rate and the false positive error rate corresponding to the matching score threshold value TH specified. The output control unit 513 may provide an interface to help users recognize the false negative error rate and the false positive error rate corresponding to a specific matching score threshold value. For example, the output control unit 513 may provide an interface that allows the user to specify a desired matching score threshold value by moving the arrow A position with the slider S, as illustrated in FIG. 16, and displays the respective values of the false negative error rate and the false positive error rate corresponding to the specified specific matching score threshold value. FIG. 16 shows an example where the false negative error rate FNIR corresponding to the specified matching score threshold value is “2.8%” and the false positive error rate FPIR corresponding to the specified matching score threshold value is “0.5%”.

### [5-4: Technical Effects of the Information Processing Apparatus 5]

The information processing apparatus 5 according to the fifth embodiment accurately estimates the false negative error rate and the false positive error rate corresponding to the matching score threshold value TH, and can present the false negative error rate and the false positive error rate corresponding to the matching score threshold value TH in an easy-to-understand manner.

### 6: Sixth Example Embodiment

Next, the sixth embodiment of the information processing apparatus, information processing method, and recording medium will be described. In the following, the sixth embodiment of the information processing apparatus, information processing method, and recording medium will be described using an information processing apparatus 6 to which the sixth embodiment of the information processing apparatus, information processing method, and recording medium is applied.

### [6-1: Configuration of the Information Processing Apparatus 6]

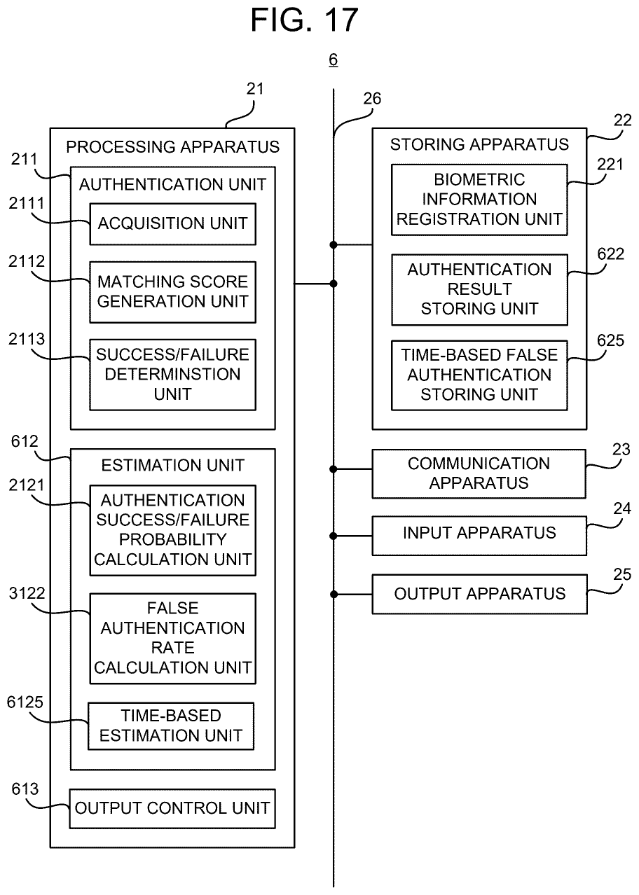

Referring to FIG. 17, the configuration of the information processing apparatus 6 according to the sixth embodiment will be described. FIG. 17 is a block diagram showing the configuration of the information processing apparatus 6 according to the sixth embodiment.

As shown in FIG. 17, the information processing apparatus 6 according to the sixth embodiment differs from the information processing apparatus 2 according to the second embodiment through the information processing apparatus 5 according to the fifth embodiment in that it includes an estimation unit 612 containing a time-based estimation unit 6125 and realizes a time-based false authentication rate storing unit 625 within the storing apparatus 22. Other features of the information processing apparatus 6 may be the same as at least one other feature of the information processing apparatus 2 through the information processing apparatus 5. Therefore, the following description will focus on the parts that differ from the previously described embodiments, and redundant descriptions will be omitted as appropriate.

### [6-2: Operations Performed by the Information Processing Apparatus 6]

An authentication result storing unit 622 of this embodiment may include information indicating the time period during which the authentication operation was performed on the authentication result. Alternatively, the authentication result storing unit 622 of this embodiment may store the authentication result for each time period.

The time-based estimation unit 6125 estimates at least one of the false negative error rate and the false positive error rate for each time period during which the authentication operation was performed. That is, the K authentication result mentioned in the third embodiment may be divided into groups by time period, and the false negative error rate and the false positive error rate may be calculated for each group. The time-based estimation unit 6125 may gradually change the matching score threshold value TH for each time period and estimate at least one of the false negative error rate and the false positive error rate for each the matching score threshold value TH changed.

That is, the estimation unit 612 may perform the estimation operation for at least one of the false rejection probability and the false acceptance probability described with reference to FIG. 5 and FIG. 6, and the estimation operation for at least one of the false negative error rate and the false positive error rate described with reference to FIG. 8 to FIG. 10, while changing the matching score threshold value as shown in FIG. 12 and FIG. 15, for each time period in which the authentication operation is performed.

The time-based estimation unit 6125 may use both the measured values stored in the authentication result storing unit 622 and the estimated values estimated based on the measured values to determine the trend of at least one of the false negative error rate and the false positive error rate for each time period.

The time-based estimation unit 6125 may store at least one of the false negative error rate and the false positive error rate estimated for each time period by gradually changing the matching score threshold value TH and storing the estimated values in the time-based false authentication rate storing unit 625.

An output control unit 613 outputs at least one of the false negative error rate and the false positive error rate for each time period in which the authentication operation was performed in a manner that allows it to be visually confirmed. The output control unit 613 may display the false negative error rate and the false positive error rate for each time period on the display as the output apparatus 25 by referring to the time-based false authentication rate storing unit 625.

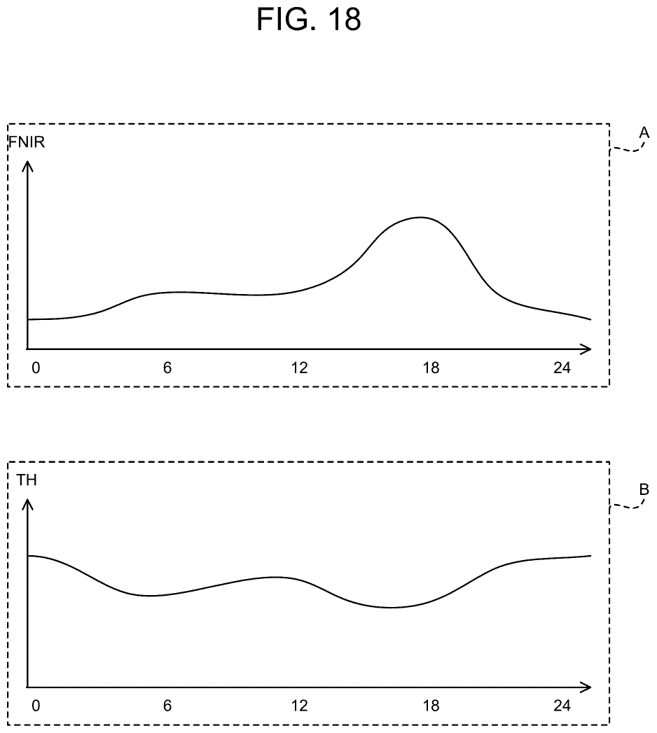

The output control unit 613 may output information in a graph of at least one of the false negative error rate and the false positive error rate for each time period, enabling the user to easily grasp changes over time. The output control unit 613 may, for example, display the false negative error rate FNIR for each time period in case the matching score threshold value TH is fixed, as illustrated in Graph A of FIG. 18. The output control unit 613 may display the false positive error rate FPIR for each time period in case the matching score threshold value TH is fixed. Graph A illustrates that the false negative error rate FNIR tends to increase during the evening time period affected by western sunlight. In other words, the output control unit 613 enables the user to understand that the false negative error rate FNIR tends to increase during the evening time period affected by western sunlight.

The output control unit 613 may also display the matching score threshold value TH corresponding to the time period in case the false negative error rate FNIR is fixed, as illustrated in Graph B of FIG. 18. Additionally, the output control unit 613 may display the matching score threshold value TH corresponding to the time period in case the false positive error rate FPIR is fixed. The output control unit 613 may output information that enables recognition of the trend of the matching score threshold value TH for each time period, thereby assisting the setter in considering the setting of the matching score threshold value.

Note that although the explanation has been given for changes corresponding to time periods on a daily basis, the estimation unit 612 may estimate changes corresponding to, for example, weekly, monthly, or yearly periods. Furthermore, it may distinguish time periods and make estimates taking into account seasonal changes. For example, since the length of the day differs between summer and winter, trends may change even during the same time period of the day. For this reason, it is possible to distinguish time periods by season and make estimates accordingly.

### [6-3: Technical Effects of the Information Processing Apparatus 6]

The information processing apparatus 6 according to the sixth embodiment can accurately estimate at least one of the false negative error rate and the false positive error rate for each time period. Since the information processing apparatus 6 presents at least one of the false negative error rate and the false positive error rate for each time period, it can support the setting of the matching score threshold value according to the time period.

### 7: Seventh Example Embodiment

Next, the seventh embodiment of the information processing apparatus, information processing method, and recording medium will be described. In the following, the seventh embodiment of the information processing apparatus, information processing method, and recording medium will be described using an information processing apparatus 7 to which the seventh embodiment of the information processing apparatus, information processing method, and recording medium is applied.

### [7-1: Configuration of the Information Processing Apparatus 7]

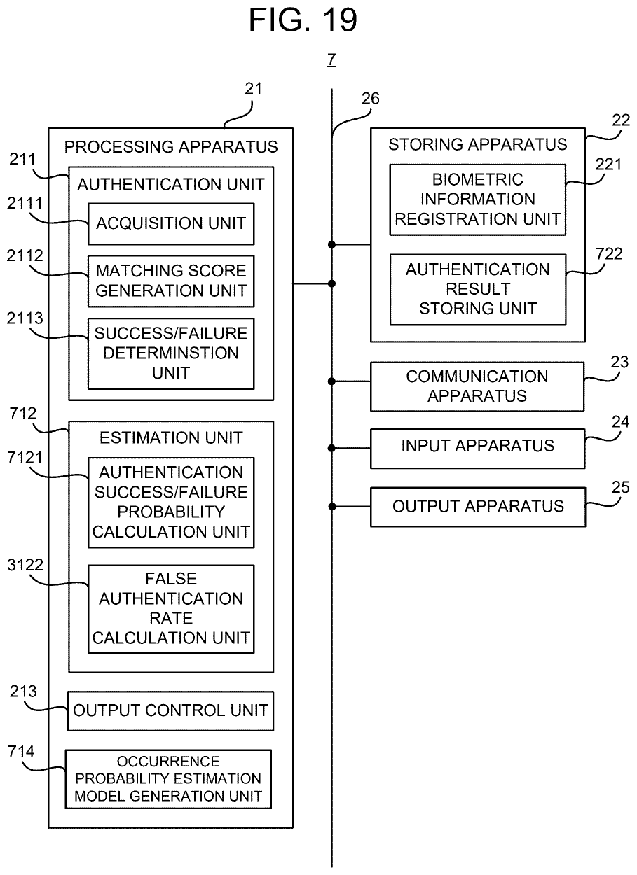

Referring to FIG. 19, the configuration of the information processing apparatus 7 according to the seventh embodiment will be described. FIG. 19 is a block diagram showing the configuration of the information processing apparatus 7 according to the seventh embodiment.

As shown in FIG. 19, the information processing apparatus 7 according to the seventh embodiment differs from the information processing apparatus 2 according to the second embodiment through the information processing apparatus 6 according to the sixth embodiment in that an occurrence probability estimation model generation unit 714 is realized in the processing apparatus 21. Other features of the information processing apparatus 7 may be the same as at least one other feature of the information processing apparatus 2 through the information processing apparatus 6. Therefore, in the following, in detail the parts that differ from the previously described embodiments will be described, and explanations of other redundant parts as appropriate will be omitted.

### [7-2: The Occurrence Probability Estimation Model]

The occurrence probability estimation model is a model that, in case the matching score generated in past matching process by the authentication unit 211 is input, outputs the occurrence probability of the matching score generated in case the matching process is performed at relevant time after the past matching process.

The occurrence probability estimation model is a model specific to the authentication mechanism used by the authentication unit 211. The occurrence probability estimation model is generated from the authentication result of biometric authentication using the authentication mechanism and is prepared in advance.

### [7-3: The Occurrence Probability Estimation Model Generation Operation of the Information Processing Apparatus 7]

The occurrence probability estimation model generation unit 714 generates the occurrence probability estimation model. The occurrence probability estimation model generation unit 714 generates the occurrence probability estimation model based on the past authentication result provided by the authentication unit 211. The occurrence probability estimation model generation unit 714 may generate the occurrence probability estimation model based on the past authentication result provided by the authentication unit 211 stored in an authentication result storing unit 722. The past authentication result stored in the authentication result storing unit 722 may include the matching score of all repeated matching process that include the matching score of the final time.

The authentication mechanism may, for example, authenticate the target approaching the authentication mechanism. In this case, since the target gradually approaches the authentication mechanism, it can be expected that the accuracy of the biometric information that can be acquired will improve with each repetition of the matching process. With each repetition of the matching process, the image becomes clearer, and it can be expected that images more suitable for the biometric authentication can be acquired. Therefore, it can be expected that the matching score will increase with each repetition. For this reason, in case of authenticating the target approaching the authentication mechanism, the occurrence probability of the matching score of the next time may be made dependent on the magnitude of the matching score of the previous time.

For example, the authentication result acquired by performing the matching process multiple times while changing the distance between the target and the camera may be stored in the authentication result storing unit 722. This storage may be performed as an experiment before the authentication mechanism is used for actual biometric authentication of a practical stage. The occurrence probability estimation model generation unit 714 may generate the occurrence probability estimation model based on the authentication result acquired from the plurality of the matching process performed as this experiment. Specifically, track the changes in the matching score between consecutive matching of the same target and determine the distribution of the matching score. Let the matching score of current be sₚ and the matching score of the next time be sₙ. Then, the distribution of sₙ for each same sₚ (sₚ within a specified range) is collected from past history, and a model for each value of sₚ is calculated.

In addition, the authentication result storing unit 722 may also store the authentication result of the matching process performed during the practical stage in case the authentication mechanism is used for actual biometric authentication. For example, the parameters of the occurrence probability estimation model may be weighted according to the authentication result accumulated during the practical stage. The authentication result accumulated during the practical stage reflects the actual conditions in which the authentication mechanism is used, so the occurrence probability estimation model can be adapted to the actual conditions. The actual conditions may include the environment in which authentication is performed and the purpose of authentication.

### [7-4: Input to the Occurrence Probability Estimation Model]

An estimation unit 712 uses the occurrence probability estimation model to calculate the occurrence probability. The estimation unit 712 inputs the matching score generated in the past matching process into the occurrence probability estimation model, and outputs the occurrence probability of the matching score generated in case the matching process is performed on the relevant time after the past matching process from the output of the occurrence probability estimation model. For example, the estimation unit 712 inputs the final matching score into the occurrence probability estimation model and outputs the occurrence probability of the matching score generated in case the matching process is performed on the next time of the final time output from the occurrence probability estimation model.

The matching score of the previous time of the relevant time after the past matching process can be inputted into the occurrence probability estimation model. In other words, in case the occurrence probability estimation model receives the matching score generated by the matching process of the current (the previous time of the relevant time after the past matching process), it can output the occurrence probability of the matching score generated by the matching process of the next time (the relevant time after the past matching process). The occurrence probability estimation model may initially be given the final matching score of the final time that ended the repetition of the matching process.

Alternatively, the occurrence probability estimation model may be input with a representative score generated based on a plurality of the matching scores generated in the matching process repeated up to the previous time of the relevant time after the past matching process. The occurrence probability estimation model may be input with the representative score (statistical representative value of scores) generated based on the plurality of the matching scores generated before the repetition of the matching process is ended. The representative score may be, for example, the average score of each the matching score. Alternatively, the representative score may be the median of each the matching score. Using the representative score as input suppresses the influence of accidentally large the matching score generated.

### [7-5: The Occurrence Probability Estimation Model of the Identity Matching Score]

The occurrence probability estimation model of the identity matching score may output the occurrence probability of the identity matching score generated in the matching process of the next time in case the identity matching score generated in the current the matching process is input.

Alternatively, the occurrence probability estimation model of the identity matching score may output the occurrence probability of the identity matching score generated in the matching process of the next time in case the representative score aforementioned is input. For example, in case performing multiple capturing in a stationary state and using the images acquired from those capturing for matching, there is no reason for the matching score to gradually increase, so it is not necessary to depend on the identity matching score of the previous time. Rather, by calculating the occurrence probability of the matching score of the next time from the representative score of the matching score generated by repeated the matching process, the estimation accuracy of the occurrence probability of the matching score may be improved.

### [7-6: The Occurrence Probability Estimation Model of the Different Identity Matching Score]

In other embodiments, the case where the occurrence probability of the different identity matching score is assumed to be independent of the different identity matching score of the previous time has been explained, but the occurrence probability of the different identity matching score may also depend on the identity matching score generated in past matching process, similar to the occurrence probability of the identity matching score.

### [7-8: Technical Effect of the Information Processing Apparatus 7]

The information processing apparatus 7 according to the seventh embodiment generates the occurrence probability estimation model and estimates the authentication information estimated using the occurrence probability estimation model, thereby enabling accurate estimation of the estimated authentication information and supporting the setting of appropriate the matching score threshold value. The information processing apparatus 7 can generate the occurrence probability estimation model that can accurately output an occurrence distribution of the matching score in case of dependent on the matching score of last time. The information processing apparatus 7 can also generate the occurrence probability estimation model that can accurately output the occurrence distribution of the matching score even in case independent of the matching score of last time.

### 8: Supplementary Note

The following supplementary note is disclosed regarding the embodiments described above.

### [Supplementary Note 1]

An information processing apparatus including:
an authentication unit that determines a success or failure of authentication of a target based on predetermined conditions and a result of a matching process that determines a success or failure of matching of the target using a matching score generated from biometric information of the target;
an estimation unit that estimates estimated authentication information regarding the success or failure of authentication of the target in case the authentication unit repeats the matching process a predetermined number of times based on a past authentication result by the authentication unit; and
an output unit that outputs the estimated authentication information.

### [Supplementary Note 2]

The information processing apparatus according to Supplementary Note 1, wherein
the predetermined conditions include:
   a condition that the authentication unit determines that the authentication of the target is successful and ends a repetition of the matching process in case the matching score exceeds a matching score threshold; and
   a condition that the authentication unit ends the repetition of the matching process in case the authentication unit repeats the matching process an upper limit number of times.

### [Supplementary Note 3]

The information processing apparatus according to Supplementary Note 1 or 2, wherein
the past authentication result includes a final matching score at a final time in case the repetition of the matching process is ended, and
the estimation unit acquires an occurrence probability of a matching score generated in case the matching process is performed after the final time according to the final matching score.

### [Supplementary Note 4]

The information processing apparatus according to Supplementary Note 3, wherein
the estimation unit estimates, using the occurrence probability, at least one of a false rejection probability indicating a probability of failure of the matching with an identical person and a false acceptance probability indicating a probability of success in the matching with a different person other than the identical person in case the authentication unit repeats the matching process the predetermined number of times for a predetermined threshold value of the matching score.

[Supplementary Note 5]

The information processing apparatus according to Supplementary Note 4, wherein
the estimation unit performs at least one of the following operations:
   estimating a false negative error rate, which is a rate of incorrectly rejecting the identical person, using the false rejection probability, for the predetermined threshold value of the matching score; and
   estimating a false positive error rate, which is a rate of incorrectly accepting a different person, using the false acceptance probability, for the predetermined threshold value of the matching score.

### [Supplementary Note 6]

The information processing apparatus according to Supplementary Note 5, wherein the estimation unit changes a threshold value of the matching score gradually and estimates at least one of the false negative error rate and the false positive error rate for each the threshold value changed.

### [Supplementary Note 7]

The information processing apparatus according to Supplementary Note 5, wherein
the output unit outputs at least one of the false negative error rate and the false positive error rate as a function of the threshold value of the matching score, and
outputs at least one of the false negative error rate and the false positive error rate corresponding to the threshold value specified in response to a specification of the threshold value.

### [Supplementary Note 8]

The information processing apparatus according to Supplementary Note 5, wherein
in case one of the false negative error rate and the false positive error rate is specified, the output unit outputs other of the false negative error rate and the false positive error rate.

### [Supplementary Note 9]

The information processing apparatus according to Supplementary Note 5, wherein
the estimation unit estimates at least one of the false negative error rate and the false positive error rate for each time period in which the matching process is performed.

### [Supplementary Note 10]

The information processing apparatus according to Supplementary Note 9, wherein
the output unit outputs at least one of the false negative error rate and the false positive error rate for each time period in which the matching process is performed.

### [Supplementary Note 11]

The information processing apparatus according to Supplementary Note 1 or 2, further including a generation unit that generates an occurrence probability estimation model that, in response to the matching score generated in past matching process by the authentication unit is input, outputs an occurrence probability of the matching score generated in case the matching process of a relevant time after the past matching process is performed, wherein
the generation unit generates the occurrence probability estimation model based on the past authentication result by the authentication unit, and
the estimation unit estimates the occurrence probability using the occurrence probability estimation model.

### [Supplementary Note 12]

The information processing apparatus according to Supplementary Note 11, wherein
the matching score generated in the past matching process by the authentication unit is a match score generated in the matching process of a previous time of the relevant time.

### [Supplementary Note 13]

The information processing apparatus according to Supplementary Note 11, wherein
the matching score generated in the past matching process is a representative score generated based on a plurality of the matching scores generated in the matching process is repeated up to a previous time of the relevant time.

### [Supplementary Note 14]

An information processing method including:
determining a success or failure of authentication of a target based on predetermined conditions and a result of a matching process that determines a success or failure of matching of the target using a matching score generated from biometric information of the target;
estimating estimated authentication information regarding the success or failure of authentication of the target in case the matching process is repeated a predetermined number of times based on a past authentication result; and
outputting the estimated authentication information.

### [Supplementary Note 15]

A recording medium on which a computer program is stored, the computer program being configured to allow a computer to execute an information processing method including:
determining a success or failure of authentication of a target based on predetermined conditions and a result of a matching process that determines a success or failure of matching of the target using a matching score generated from biometric information of the target;
estimating estimated authentication information regarding the success or failure of authentication of the target in case the matching process is repeated a predetermined number of times based on a past authentication result; and
outputting the estimated authentication information.

This disclosure may be changed as appropriate within the scope that does not contradict the technical idea that can be read from the claims and the entire description. The information processing apparatus, information processing method, and recording medium with such changes are also included in the technical idea of this disclosure.

### DESCRIPTION OF REFERENCE CODES

1, 2, 3, 4, 5, 6, 7 information processing apparatus
11, 211 authentication unit
12, 212, 312, 412, 512, 612, 712 estimation unit
13 output unit
213, 413, 513, 613 output control unit
2111 acquisition unit
2112 matching score generation unit
2113 success/failure determination unit
2121 authentication success/failure probability calculation unit
221 biometric information registration unit
222, 322, 622, 722 authentication result storing unit
3122 false authentication rate calculation unit
4123 table generation unit
423 table storing unit
5124 function generation unit
524 function storing unit
6125 time-based estimation unit
625 time-based false authentication rate storing unit
714 occurrence probability estimation model generation unit

What is claimed is:

1. An information processing apparatus comprising:
at least one memory storing instructions; and
at least one processor that is configured to execute the instructions to:
determine a success or failure of authentication of a target based on predetermined conditions and a result of a matching process that determines a success or failure of matching of the target using a matching score generated from biometric information of the target;
estimate estimated authentication information regarding the success or failure of authentication of the target in case the matching process is repeated a predetermined number of times based on a past authentication; and
output the estimated authentication information.

2. The information processing apparatus according to claim 1, wherein
the predetermined conditions include:
a condition that the authentication of the target is determined to be successful and a repetition of the matching process is ended in case the matching score exceeds a matching score threshold; and
a condition that the repetition of the matching process is ended in case the matching process is repeated an upper limit number of times.

3. The information processing apparatus according to claim 1, wherein
the past authentication result includes a final matching score at a final time in case the repetition of the matching process is ended, and
the at least one processor that is configured to execute the instructions to acquire an occurrence probability of a matching score generated in case the matching process is performed after the final time according to the final matching score.

4. The information processing apparatus according to claim 3, wherein
the at least one processor that is configured to execute the instructions to estimate, using the occurrence probability, at least one of a false rejection probability indicating a probability of failure of the matching with an identical person and a false acceptance probability indicating a probability of success in the matching with a different person other than the identical person in case the matching process is repeated the predetermined number of times for a predetermined threshold value of the matching score.

5. The information processing apparatus according to claim 4, wherein
the at least one processor that is configured to execute the instructions to perform at least one of the following operations:
estimating a false negative error rate, which is a rate of incorrectly rejecting the identical person, using the false rejection probability, for the predetermined threshold value of the matching score; and
estimating a false positive error rate, which is a rate of incorrectly accepting a different person, using the false acceptance probability, for the predetermined threshold value of the matching score.

6. The information processing apparatus according to claim 5, wherein
the at least one processor that is configured to execute the instructions to:
change a threshold value of the matching score gradually; and
estimate at least one of the false negative error rate and the false positive error rate for each the threshold value changed.

7. The information processing apparatus according to claim 5, wherein
the at least one processor that is configured to execute the instructions to:
output at least one of the false negative error rate and the false positive error rate as a function of the threshold value of the matching score; and
output at least one of the false negative error rate and the false positive error rate corresponding to the threshold value specified in response to a specification of the threshold value.

8. The information processing apparatus according to claim 5, wherein
in case one of the false negative error rate and the false positive error rate is specified, the at least one processor that is configured to execute the instructions to output other of the false negative error rate and the false positive error rate.

9. The information processing apparatus according to claim 5, wherein
the at least one processor that is configured to execute the instructions to estimate at least one of the false negative error rate and the false positive error rate for each time period in which the matching process is performed.

10. The information processing apparatus according to claim 9, wherein
the at least one processor that is configured to execute the instructions to output at least one of the false negative error rate and the false positive error rate for each time period in which the matching process is performed.

11. The information processing apparatus according to claim 1, wherein the at least one processor that is configured to execute the instructions to:
generate an occurrence probability estimation model that, in response to the matching score generated in past matching process is input, outputs an occurrence probability of the matching score generated in case the matching process of a relevant time after the past matching process is performed;
generate the occurrence probability estimation model based on the past authentication result; and
estimate the occurrence probability using the occurrence probability estimation model.

12. The information processing apparatus according to claim 11, wherein
the matching score generated in the past matching process is a match score generated in the matching process of a previous time of the relevant time.

13. The information processing apparatus according to claim 11, wherein
the matching score generated in the past matching process is a representative score generated based on a plurality of the matching scores generated in the matching process is repeated up to a previous time of the relevant time.

14. An information processing method comprising:
determining a success or failure of authentication of a target based on predetermined conditions and a result of a matching process that determines a success or failure of matching of the target using a matching score generated from biometric information of the target;
estimating estimated authentication information regarding the success or failure of authentication of the target in case the matching process is repeated a predetermined number of times based on a past authentication result; and
outputting the estimated authentication information.

15. A non-transitory recording medium on which a computer program is stored, the computer program being configured to allow a computer to execute an information processing method comprising:
determining a success or failure of authentication of a target based on predetermined conditions and a result of a matching process that determines a success or failure of matching of the target using a matching score generated from biometric information of the target;
estimating estimated authentication information regarding the success or failure of authentication of the target in case the matching process is repeated a predetermined number of times based on a past authentication result; and
outputting the estimated authentication information.
